(19) United States
(12) Patent Application Publication
(10) Pub. No.: US 2008/0197518 A1
(43) Pub. Date: Aug. 21, 2008

(54) Shaped article with polymer domains and process

(75) Inventors: Peter T. Aylward, Hilton, NY (US); Thomas M. Laney, Spencerport, NY (US); Jehuda Greener, Rochester, NY (US); Charles C. Anderson, Penfield, NY (US)

Correspondence Address: Edwin Oh;Rohm and Haas Electronic Materials LLC, 455 Forest Street, Marlborough, MA, 01752, US

(73) Assignee: Rohm and Haas Denmark Finance A/S, Copenhagen (DK)

(21) Appl. No.: 12/002,782

(22) Filed: Dec. 18, 2007

Related U.S. Application Data
(60) Provisional application No. 60/875,457, filed on Dec. 18, 2006.

(51) Int. Cl. G02B 5/30

(52) U.S. Cl. 264/1.34

(57) ABSTRACT

A process for making a multiphase birefringent film and resulting shaped article comprise (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction

The shaped article and process for making provides a diffusely reflecting polarizer.

### FIELD OF THE INVENTION

This invention relates to a diffusely reflecting optical element comprising a shaped article (a) a first polymeric material forming a continuous phase in all directions and (b) a second polymeric material that is continuous in only one direction disposed within the first phase, the second polymeric material being predominately curvilinear in its end cross sectional shape and substantially extending the length of the film, at least one of the phases being birefringent and the two phases being substantially matched in refractive index in at least one direction. The shaped article is a diffusely reflecting polarizer film.

Additionally a process for making a shaped article is described as well as a process for making a diffusely reflecting polarizer

### BACKGROUND OF THE INVENTION

Reflective polarizing films transmit light of one polarization and reflect light of the orthogonal polarization. They are useful in an LCD to enhance light efficiency. A variety of films have been disclosed to achieve the function of the reflective polarizing films, among which diffusely reflecting polarizers are more attractive because they may not need a diffuser in a LCD, thus reducing the complexity of the LCD.

U.S. Pat. Nos. 5,783,120 and 5,825,543 teach a diffusely reflecting polarizing film including a first birefringent phase and a second phase, wherein the first phase having a birefringence of at least about 0.05. The film is oriented, typically by stretching, in one or more directions. The size and shape of the disperse phase particles, the volume fraction of the disperse phase, the film thickness, and the amount of orientation are chosen to attain a desired degree of diffuse reflection and total transmission of electromagnetic radiation of a desired wavelength in the resulting film. Among 124 samples shown in Table 1 through Table 4, most of which include polyethylene naphthalate (PEN) as a major and birefringent phase (more than 50% of the blend), with PMMA (Example 1) or sPS (other examples) as a minor phase (less than 50% of the blend), except example numbers 6, 8, 10, 15, 16, 42-49, wherein PEN is the minor phase.

U.S. Pat. Nos. 5,783,120 and 5,825,543 also summarize a number of alternative films, which are described below.

Films filled with inorganic inclusions with different characteristics can provide optical transmission and reflective properties. However, optical films made from polymers filled with inorganic inclusions suffer from a variety of infirmities. Typically, adhesion between the inorganic particles and the polymer matrix is poor. Consequently, the optical properties of the film decline when stress or strain is applied across the matrix, both because the bond between the matrix and the inclusions is compromised, and because the rigid inorganic inclusions may be fractured. Furthermore, alignment of inorganic inclusions requires process steps and considerations that complicate manufacturing.

Other films, such as that disclosed in U.S. Pat. No. 4,688,900 (Doane et. al.), consists of a clear light-transmitting continuous polymer matrix, with droplets of light modulating liquid crystals dispersed within. Stretching of the material reportedly results in a distortion of the liquid crystal droplet from a spherical to an ellipsoidal shape, with the long axis of the ellipsoid parallel to the direction of stretch. U.S. Pat. No. 5,301,041 (Konuma et al.) make a similar disclosure, but achieve the distortion of the liquid crystal droplet through the application of pressure. A. Aphonin, “Optical Properties of Stretched Polymer Dispersed Liquid Crystal Films Angle-Dependent Polarized Light Scattering, Liquid Crystals, Vol. 19, No. 4, 469-480 (1995), discusses the optical properties of stretched films consisting of liquid crystal droplets disposed within a polymer matrix. He reports that the elongation of the droplets into an ellipsoidal shape, with their long axes parallel to the stretch direction, imparts an oriented birefringence (refractive index difference among the dimensional axes of the droplet) to the droplets, resulting in a relative refractive index mismatch between the dispersed and continuous phases along certain film axes, and a relative index match along the other film axes. Such liquid crystal droplets are not small as compared to visible wavelengths in the film, and thus the optical properties of such films have a substantial diffuse component to their reflective and transmissive properties. Aphonin suggests the use of these materials as a polarizing diffuser for backlit twisted nematic LCDs. However, optical films employing liquid crystals as the disperse phase are substantially limited in the degree of refractive index mismatch between the matrix phase and the dispersed phase. Furthermore, the birefringence of the liquid crystal component of such films is typically sensitive to temperature.

U.S. Pat. No. 5,268,225 (Isayev) discloses a composite laminate made from thermotropic liquid crystal polymer blends. The blend consists of two liquid crystal polymers which are immiscible with each other. The blends may be cast into a film consisting of a dispersed inclusion phase and a continuous phase. When the film is stretched, the dispersed phase forms a series of fibers whose axes are aligned in the direction of stretch. While the film is described as having improved mechanical properties, no mention is made of the optical properties of the film. However, due to their liquid crystal nature, films of this type would suffer from the infirmities of other liquid crystal materials discussed above.

Still other films have been made to exhibit desirable optical properties through the application of electric or magnetic fields. For example, U.S. Pat. No. 5,008,807 (Waters et al.) describes a liquid crystal device which consists of a layer of fibers permeated with liquid crystal material and disposed between two electrodes. A voltage across the electrodes produces an electric field which changes the birefringent properties of the liquid crystal material, resulting in various degrees of mismatch between the refractive indices of the fibers and the liquid crystal. However, the requirement of an electric or magnetic field is inconvenient and undesirable in many applications, particularly those where existing fields might produce interference.

Other optical films have been made by incorporating a dispersion of inclusions of a first polymer into a second polymer, and then stretching the resulting composite in one or two directions. U.S. Pat. No. 4,871,784 (Otonari et al.) is exemplative of this technology. The polymers are selected such that there is low adhesion between the dispersed phase and the surrounding matrix polymer, so that an elliptical void is formed around each inclusion when the film is stretched. Such voids have dimensions of the order of visible wavelengths. The refractive index mismatch between the void and the polymer in these “microvoided” films is typically quite large (about 0.5), causing substantial diffuse reflection. However, the optical properties of microvoided materials are difficult to control because of variations of the geometry of the interfaces, and it is not possible to produce a film axis for which refractive indices are relatively matched, as would be useful for polarization-sensitive optical properties. Furthermore, the voids in such material can be easily collapsed through exposure to heat and pressure.

Optical films are disclosed in U.S. Pat. Nos. 3,556,635 and 3,801,429 (Schrenk). Such film and means of making are multi-layer stacks or layers of polymer with alternating degrees of birefringence or refractive index. In this case both polymer phases are physical separated from each other and are continuous within each layer of the stack. They only share alternating surface contact with each other. Such film are difficult to make and require a complex means of splitting and recombining polymer flow during the melt extrusion process. Such films also require precise and accurate control of the layer thickness and furthermore need to be designed in stacks of approximately 20-30 alternating layers to achieve high reflectance but in a narrow spectral band. In order to provide films with full and uniform visible light performance, multiple stacks with varying thickness are needed. If this is not done with the proper control, the resulting film will be color biased and not provide the most uniform performing film.

Optical films have also been made wherein a dispersed phase is deterministically arranged in an ordered pattern within a continuous matrix. U.S. Pat. Nos. 5,217,794 and 5,316,703 (Schrenk) is exemplative of this technology. There, a lamellar polymeric film and method are disclosed which is made of polymeric inclusions which are large compared with wavelength on two axes, disposed within a continuous matrix of another polymeric material. The refractive index of the dispersed phase differs significantly from that of the continuous phase along one or more of the laminate's axes, and is relatively well matched along another. Because of the ordering of the dispersed phase, films of this type exhibit strong iridescence (i.e., interference-based angle dependent coloring) for instances in which they are substantially reflective. Furthermore the films discussed in these disclosures provide only for flat ribbon-like structures. As a result, such films have seen limited use for optical applications where optical diffusion is desirable.

The performance potential and flexibility of polarized displays, especially those utilizing the electro-optic properties of liquid crystalline materials, has led to a dramatic growth in the use of these displays for a wide variety of applications. Liquid crystal displays (LCDs) offer the full range from extremely low cost and low power performance (e.g. wristwatch displays) to very high performance and high brightness (e.g. AMLCDs for avionics applications, computer monitors and HDTV LCD's). Much of this flexibility comes from the light valve nature of these devices, in that the imaging mechanism is decoupled from the light generation mechanism. While this is a tremendous advantage, it is often necessary to trade performance in certain categories such as luminance capability or light source power consumption in order to maximize image quality or affordability. This reduced optical efficiency can also lead to performance restrictions under high illumination due to heating or fading of the light-absorbing mechanisms commonly used in the displays.

In portable display applications such as backlit laptop computer monitors or other instrument displays, battery life is greatly influenced by the power requirements of the display backlight. Thus, functionality must be compromised to minimize size, weight and cost. Avionics displays and other high performance systems demand high luminance but yet place restrictions on power consumption due to thermal and reliability constraints. Projection displays are subject to extremely high illumination levels, and both heating and reliability must be managed. Head mounted displays utilizing polarized light valves are particularly sensitive to power requirements, as the temperature of the display and backlight must be maintained at acceptable levels.

Previous disclosure displays suffer from low efficiency, poor luminance uniformity, insufficient luminance and excessive power consumption which generates unacceptably high levels of heat in and around the display. Previous disclosure displays also exhibit a non-optimal environmental range due to dissipation of energy in temperature sensitive components. Backlight assemblies are often excessively large in order to improve the uniformity and efficiency of the system.

Several areas for efficiency improvement are readily identified. Considerable effort has gone into improving the efficiency of the light source (e.g. fluorescent lamps) and optimizing the reflectivity and light distribution of backlight cavities to provide a spatially uniform, high luminance light source behind the display. Pixel aperture ratios are made as high as the particular LCD approach and fabrication method will economically allow. Where color filters are used, these materials have been optimized to provide a compromise between efficiency and color gamut Reflective color filters have been proposed for returning unused spectral components to a backlight cavity.

When allowed by the display requirements, some improvement can also be obtained by constricting the range of illumination angles for the displays via directional techniques.

Even with this previous disclosure optimization, lamp power levels must be undesirably high to achieve the desired luminance. When fluorescent lamps are operated at sufficiently high power levels to provide a high degree of brightness for a cockpit environment, for example, the excess heat generated may damage the display. To avoid such damage, this excess heat must be dissipated. Typically, heat dissipation is accomplished by directing an air stream to impinge upon the components in the display. Unfortunately, the cockpit environment contains dirt and other impurities which are also carried into the display with the impinging air, if such forced air is even available. Presently available LCD displays cannot tolerate the influx of dirt and are soon too dim and dirty to operate effectively.

Another drawback of increasing the power to a fluorescent lamp is that the longevity of the lamp decreases dramatically as ever higher levels of surface luminance are demanded. The result is that aging is accelerated which may cause abrupt failure in short periods of time when operating limitations are exceeded.

Considerable emphasis has also been placed on optimizing the polarizers for these displays. By improving the pass-axis transmittance (approaching the theoretical limit of 50%), the power requirements have been reduced, but the majority of the available light is still absorbed, constraining the efficiency and leading to polarizer reliability issues in high throughput systems as well as potential image quality concerns.

A number of polarization schemes have been proposed for recapturing a portion of the otherwise lost light and reducing heating in projection display systems. These include the use of Brewster angle reflections, thin film polarizers, birefringent crystal polarizers and cholesteric circular polarizers. While somewhat effective, these previous disclosure approaches are very constrained in terms of illumination or viewing angle, with several having significant wavelength dependence as well. Many of these add considerable complexity, size or cost to the projection system, and are impractical on direct view displays. None of these previous disclosure solutions are readily applicable to high performance direct view systems requiring wide viewing angle performance.

Also taught in the previous disclosure (U.S. Pat. No. 4,688,897) is the replacement of the rear pixel electrode in an LCD with a wire grid polarizer for improving the effective resolution of twisted nematic reflective displays, although this reference falls short of applying the reflective polarizing element for polarization conversion and recapture. The advantages which can be gained by the approach, as embodied in the previous disclosure, are rather limited. It allows, in principle, the mirror in a reflective LCD to be placed between the LC material and the substrate, thus allowing the TN mode to be used in reflective mode with a minimum of parallax problems. While this approach has been proposed as a transflective configuration as well, using the wire grid polarizer instead of the partially-silvered mirror or comparable element, the previous disclosure does not provide means for maintaining high contrast over normal lighting configurations for transflective displays. This is because the display contrast in the backlit mode is in the opposite sense of that for ambient lighting. As a result, there will be a sizable range of ambient lighting conditions in which the two sources of light will cancel each other and the display will be unreadable. A further disadvantage of the previous disclosure is that achieving a diffusely reflective polarizer in this manner is not at all straightforward, and hence the reflective mode is most applicable to specular, projection type systems.

Taught in the previous disclosure (U.S. Pat. No. 2,604,817) and later in the previous disclosure (U.S. Pat. No. 5,999,239) is one such means to produce a diffusely reflective polarizer utilizing polymeric fibers dispersed in a continuous polymer matrix. Typical monofilament birefringent fibers (ex, polyester) were demonstrated to create such a diffuse reflective polarizer in (U.S. Pat. No. 2,604,817). These fibers are embedded into an isotropic polymer matrix. The manufacturability and optical performance of such a reflective polarizer utilizing even the smallest typical monolithic birefringent fibers, however, is not sufficient enough to enable such a diffuse reflective polarizer to be cost effective.

There still remains a need for an optical film comprising an optical element comprising a film containing a layer including continuous phase and ordered discontinuous phase materials, wherein the discontinuous phase materials are include a birefringent material having a different refractive index in the orthogonal X and Y directions in a plane perpendicular to the direction of light travel and a process for making same.

### SUMMARY OF THE INVENTION

The invention provides an optical element and a process for making such an optical element. The element is a diffusive reflective polarizer with a mismatched discontinuous phase that provides improved Figure of Merit.

### BRIEF DESCRIPTION OF THE DRAWINGS

FIG. 1 is a cross-sectional view of a prior art reflective polarizer film with more than one stacked paired layer with alternating polymer layers with different refractive index.

FIG. 2 is a cross-sectional view of a prior art film with a random alternating polymer interfaces created from stretching two immiscible polymers.

FIG. 3 is a 3 dimensional view of an inventive film with fibrils

FIG. 4 is a 3 dimensional view of inventive film with domains that are elongated ellipses and embedded internal to a continuous phase polymer.

FIG. 5 is a 3 dimensional view of an inventive film with domains that are triangular in shapes.

FIG. 6 is a cross sectional view of an inventive film with domains that vary in shape and dimension.

FIG. 7 is a 3 dimensional view of a reflective polarizer with domains with varying shape within its cross-sectional thickness.

FIG. 8 is a 3 dimensional cross-sectional view of a reflective polarizer with no continuous polymer domains in its width or thickness plane.

FIG. 9 is an end cross sectional view of a reflective polarizer with predetermined circular to slightly oval shape polymers domains.

FIG. 10 is a cross-sectional view of a multi-layer reflective polarizer with polymer skins and with polymers domains.

FIG. 11 is a cross-sectional view of a two layer reflective polarizer with polarizer layers and clear layer FIG. 12A is cross sectional view on a reflective polarizer with predetermined polymers domains with a patterned surfaces.

FIG. 12B is cross sectional view on a reflective polarizer with predetermined polymers domains with a patterned surfaces.

FIG. 12C is cross sectional view on a reflective polarizer with predetermined polymers domains with a patterned surfaces.

FIG. 12D is cross sectional view on a reflective polarizer with predetermined polymers domains with a patterned surfaces

FIG. 13 A is a typical 3D cross section of a ribbon-like structure

FIG. 13 B is a typical 3D cross section of a ribbon-like structure with rounded corners.

FIG. 14 A is a cross-sectional view of cylinders and cylinder-like predetermined domains.

FIG. 14 B is a cross-sectional view of cylinders and cylinder-like with a slightly elongated cylinder shape predetermined domains.

FIG. 14 C is a 3D cross-section view of a cylinder shape.

FIG. 14 D is a 3D cross-section of an slightly oval cylinder-like shape with a cylinder projection.

FIG. 15 A is an end cross-sectional views of oval shapes domain.

FIG. 15 B is an end cross-sectional views of elongated oval shapes domain.

FIG. 15 C is an irregular shaped elongated oval-like domain

FIG. 15 D an elongated oval-like shape projected over an irregular elongated oval-like shape domain.

FIG. 16 is a plate-like shaped domain.

FIG. 17 A is an irregular shaped domain without flat surfaces.

FIG. 17B is another irregular shape fibril that does not appears to be a ribbon-like, cylinder-like or oval-like.

FIG. 18 A is an end cross-sectional view of triangular and triangular-like shaped domain.

FIG. 18 B is an end cross-sectional view of triangular and triangular-like shaped domain.

FIG. 18 C is an end cross-sectional view of triangular and triangular-like shaped domain.

FIG. 18 D is an end cross-sectional view of triangular and triangular-like shaped domain.

FIG. 19 A is a end cross section of rhombic multi-sided shaped domain

FIG. 19 B is a end cross section of rhombic multi-sided shaped domain FIG. 19 C is a end cross section of polygon shaped domain

FIG. 20 A is a combination reflective polarizer

FIG. 20 B is a combination reflective polarizer

FIG. 20 C is a combination reflective polarizer

FIG. 20 D is a combination reflective polarizer.

FIG. 21 is a cross section of a cylinder-like shaped domain before and after stretching and an oval-like shaped domain.

FIG. 22 is a cross section of a oval-like shaped domain before and after stretching and an oval-like shaped domain.

FIG. 23 is a 3D cross section of a second polymeric material that is continuous in only one direction disposed within the first phase with discontinuous domains.

FIG. 24A is an end cross section of a partially shaped domain

FIG. 24B is an end cross section of a partially shaped domain

FIG. 24C is an end cross section of a partially shaped domain

FIG. 24D is an end cross section of a partially shaped domain

FIG. 24E is an end cross section of a partially shaped domain

FIG. 25 A is end cross sections of a ribbon-like polymer domain

FIG. 25 B is end cross sections of a curvilinear polymer domain

### DETAILED DESCRIPTION OF THE INVENTION

The present invention substantially eliminate the various problems inherent in the previous disclosure screens and provides an improved polarizing optical film By extruding a multiphase birefringent film comprising (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction.

The polymeric film of this invention comprise second polymeric material (discontinuous phase) that is continuous in only one direction disposed within the first phase, the second polymeric material being predominately curvilinear in shape and substantially extending the length of the film. The terms shape and domains may be used interchangeable. The domains are substantially parallel to each other and dispersed in a polymeric continuous phase (a first polymeric material forming a continuous phase in all directions). The domains are substantially aligned in a parallel array by the extrusion die, orifice and flow plates during the extrusion process and is extruded as a continuous solid film. There is no need to provide a secondary means for alignment. The polymers that comprise the domains vs. the surrounding continuous phase first polymer (sea polymer) or matrix are fed separately by melt extruders and/or pumps into the flow distribution plates and are brought into surface contact with each other in the flow distribution plates and dies. This process and the resulting film are uniquely different from a process of mixing two immiscible polymers together and processing them through a single melt extruder or melt pump. Forming a film from a blend of two or more immiscible polymers and then stretching it to form polymeric interfaces is a difficult process to control and to assure the resulting polymer forms the required number of optical interfaces or the correct optical dimensions. This process relies heavily on the thermodymanics of the two polymer to form interfaces of the correct dimension. The two polymers have widely separated processing conditions and when they are dry blended prior to melting, at best the extrusion parameters are not optimal for either polymer. This creates a process that is not very robust and repeatable. Being able to feed, melt and extrude polymers that have different optimized processing conditions provides a large process advantage over immiscible blends. The polymer interfaces are substantially spatially predetermined in their relative shape and spacing by the flow plates. It should be noted that if the sample is oriented the general shape may change slightly due to the elongation of the domain in either the cross and/or length direction. The spacing between the feature may also change slightly as adjacent domains are pulled toward each other. The second polymeric material (domains) may be fibrils that arecircular or cylinder-like, oval or elongated ovals. Other shapes and relative dimension are discussed later. Since the films of this invention are stretched in at least one direction, the starting shape may be different than the end shape. It is therefore useful to modify the domain shape during extrusion to the point of providing an end shape that is useful. The process of forming the domain comprising film further enhances the polarization effect by making them more transparent to one phase of light and more reflective to the other phase of light. The polymer domains within the film are parallel to each other within 5 degrees of each other within at least one dimension (X, Y and or Z). Furthermore it is desirable to have the polymer domains substantially parallel to each other in order to provide the maximum polarization efficiency of the optical film. The formation of polymer domains provides an advantage over alternating immiscible polymer regions in that the size, shape and spacing can be controlled. Alternating immiscible regions at best are made using a compromised non-optimum processing conditions or a delicate balance of polymer addenda that compensates for the processing conditions and nature of the incompatible polymers.

It is, therefore, an object of the present invention to improve the optical efficiency of polarized displays, especially direct view liquid crystal displays (LCDs).

It is a further object of the present invention to provide this efficiency increase while retaining wide viewing angle capability and minimize the introduction of chromatic shifts or spatial artifacts.

It is a further object of the present invention to reduce the absorption of light by polarized displays, minimizing heating of the displays and degradation of the display polarizers.

It is a further object of the present invention to provide an LCD having increased display brightness.

It is yet a further object of the present invention to reduce the power requirements for LCD backlight systems.

It is yet a further object of the present invention to improve display backlight uniformity without sacrificing performance in other areas.

It is still a further object of the present invention to achieve these objects by using a process that enables a cost-effective means to produce an efficient reflective polarizer for use in LCD backlight systems.

Cost-effectiveness is achieved by utilizing a unique island-in-the sea film design and a unique extrusion process to create a diffusely reflective polarizer.

### DEFINITIONS

The terms “specular reflectivity”, “specular reflection”, or “specular reflectance” Rₛ refer to the reflectance of light rays into an emergent cone with a vertex angle of 16 degrees centered around the specular angle. The terms “diffuse reflectivity”, “diffuse reflection”, or “diffuse reflectance” refer to the reflection of rays that are outside the specular cone defined above. The terms “total reflectivity”, “total reflectance”, or “total reflection” refer to the combined reflectance of all light from a surface. Thus, total reflection is the sum of specular and diffuse reflection.

Similarly, the terms “specular transmission” and “specular transmittance” are used herein in reference to the transmission of rays into an emergent cone with a vertex angle of 16 degrees centered around the specular direction. The terms “diffuse transmission” and “diffuse transmittance” are used herein in reference to the transmission of all rays that are outside the specular cone defined above. The terms “total transmission” or “total transmittance” refer to the combined transmission of all light through an optical body. Thus, total transmission is the sum of specular and diffuse transmission. In general, each diffusely reflecting polarizer is characterized by a diffuse reflectivity R_{1d}, a specular reflectivity R₁ₛ, a total reflectivity R₁ₜ, a diffuse transmittance T_{1d}, a specular transmittance T₁ₛ, and a total transmittance T₁ₜ, along a first axis for one polarization state of electromagnetic radiation, and a diffuse reflectivity R_{2d}, a specular reflectivity R₂ₛ, a total reflectivity R₂ₜ, a diffuse transmittance T_{2d}, a specular transmittance T₂ₛ, and a total transmittance T₂ₜ along a second axis for another polarization state of electromagnetic radiation. The first axis and second axis are perpendicular to each other and each is perpendicular to the thickness direction of the diffusely reflecting polarizer. Without the loss of generality, the first axis and the second axis are chosen such as the total reflectivity along the first axis is greater than that along the second axis (i.e., R₁ₜ>R₂ₜ) and the total transmittance along the first axis is less than that along the second axis (i.e., T₁ₜ<T₂ₜ).

Diffuse reflectivity, specular reflectivity, total reflectivity, diffuse transmittance, specular transmittance, total transmittance, as used herein, generally have the same meanings as defined in U.S. Pat. Nos. 5,783,120 and 5,825,543.

The terms ribbon and ribbon-like refers to a structure or feature that is rectilinear is it shape. That is it has two major surfaces and two minor surfaces that forms a rectangle with the major surfaces and the minor surface substantially parallel respectively to each other and the length and width directions of the film. The corners may be slightly rounded. Ribbons are not cylinders or elongated cylinders. They are not oval or elongated ovals. They are not triangular or irregular in shape nor are they trapezoidal or rhombic in shape. Ribbons typically have surfaces that are flat and are wider than high. A rule of thumb is that they have a width to height ratio of between 4-1 to 8-1. Plate-like structures have a width to height ratio of greater than 10-1 and taper to an elongated point or blunt point.

### Figure of Merit (FOM)

The diffusely reflecting polarizers made according to the present invention all satisfy

R_{1d}>R₁ₛ Equation (1)

T_{2d}>T₂ₛ. Equation (2)

FOM≡T₂ₜ/(1−0.5(R₁ₜ+R₂ₜ))>1.35 Equation (3)

The equations (1) and (2) mean that the reflecting polarizers of the present invention are more diffusive than specular. It is noted that a wire grid polarizer (available from Moxtek, Inc., Orem, Utah), a multilayer interference-based polarizer such as Vikuiti™. Dual Brightness Enhancement Film, manufactured by 3M, St. Paul, Minn., or a cholesteric liquid crystal based reflective polarizer is more specular than diffusive.

Equation (3) defines the figure of merit FOM≡T₂ₜ/(1−0.5(R₁ₜ+R₂ₜ)) for the diffusively reflecting polarizer and the figure of merit FOM is greater than 1.35. For polarization recycling, what matters is the total reflection and total transmission, so only total reflection and total transmission are used to compute the FOM for the purpose of ranking different reflective polarizers. The figure of merit describes the total light throughput of a reflective polarizer and an absorptive polarizer such as a back polarizer used in an LCD, and is essentially the same as equation (1)

$$T 1 = \frac{{T}_{p}}{1 - 0.5 ( {R}_{s} + {R}_{p} ) R}$$

discussed in U.S. Patent Application Publication No. 2006/0061862, which applies to LCD systems where the light recycling is effected using a diffusive reflector or its equivalent. It is noted that R accounts for the reflectivity of the recycling reflective film, or the efficiency associated with each light recycling. In an ideal case, R is equal to 1, which means that there is no light loss in the light recycling. When R is less than 1, there is some light loss in the light recycling path. It is also noted that other forms of figure of merit can be used, however, the relative ranking of the reflective polarizers remain the same. For the purpose of quantifying and ranking the performance of a reflective polarizer, FOM≡T₂ₜ/(1−0.5(R₁ₜ+R₂ₜ)) will be used in this application. The extinction ratio T₂ₜ/T₁ₜ or R₁ₜ/R₂ₜ may not be proper to describe a reflective polarizer because a reflective polarizer having a higher T₂ₜ/T₁ₜ or R₁ₜ/R₂ₜ may not necessarily perform better than one having a lower extinction ratio. For an ideal conventional absorptive polarizer, T₂ₜ=1, R₁ₜ=R₂ₜ=0, so FOM=1. For an ideal reflective polarizer, T₂ₜ=1, R₁ₜ=1, and R₂ₜ=0, so FOM=2.

Sea Polymer is Also Referred to as a Continuous Phase Polymer (First Polymeric Material)

Polymer domains, second polymeric material may also be referred to as a discontinuous phase polymer. In some references the substantially spatially predetermined domains are also second polymeric material.

The term second polymeric material is defined as a material phase in a film that is discontinuous in the end cross sectional plane of the film but either continuous in the length direction or otherwise elongated to a dimension in the length direction at least 500 times greater than the largest dimension in the cross section plane.

Extrusion melting temperature is defined here as a temperature at which the viscosity of the melted polymer is in a range that enables processing at reasonable pressures, and will be defined here as 100 degrees C. above the glass transition temperature of the polymer.

Onset melting temperature is defined here as the temperature near the melting point of the polymer at which thermal energy is first observed to be seen imparted to the second polymeric material when heating it up during a standard differential scanning calorimeter measurement.

The polarizing screen of the present invention is a reflective polarizer that is useful in recycling light that is otherwise rejected by the LC layer. This effectively allows for enhanced optical performance and increased light (brightness) entering the LC layer.

### Figures

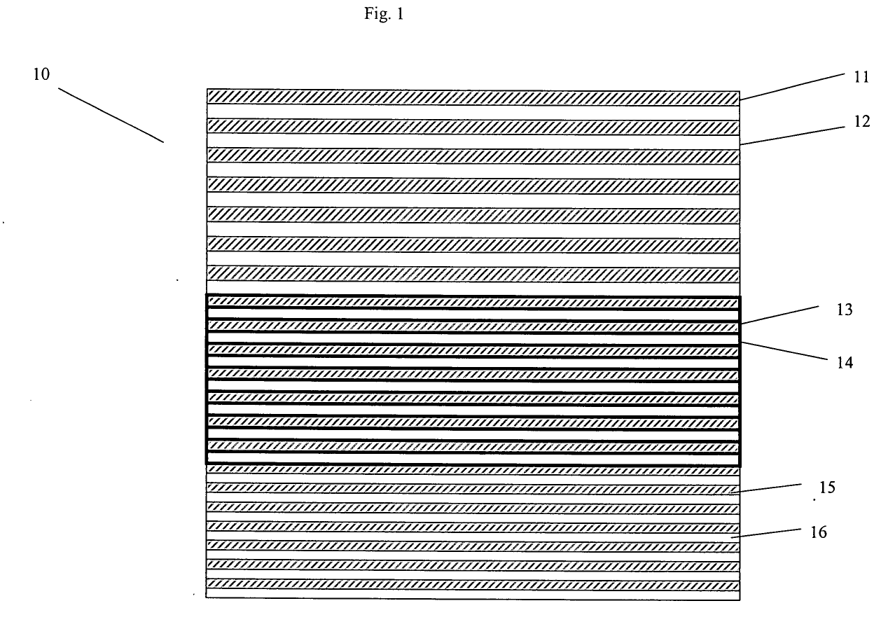

FIG. 1 is a cross-sectional view of a prior art reflective polarizer film 10 with more than one stacked paired layer with alternating polymer layers 11 and 12 with different refractive index and of one size. Film 10 has another paired stack of alternating polymer layers 13 and 14 with a different thickness than the other stacks and another stacked paired of a different thickness of alternating 15 and 16 with yet another thickness. Such a film is highly specular in its reflection properties. It has a very regular alternating thickness of alternating polymer layers.

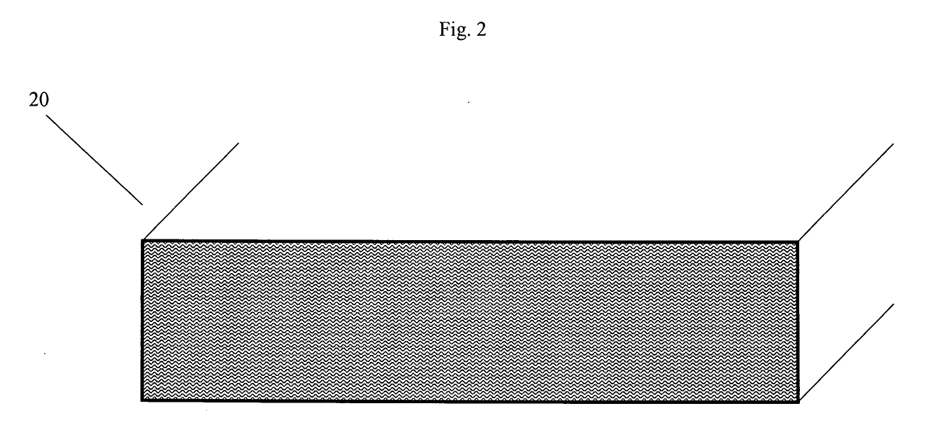

FIG. 2 is a cross-sectional view of a prior art film 20 with a random alternating polymer interfaces created from stretching two immiscible polymers. Such a film is diffusive in its reflection properties. Such a film requires the blens and extrusion of two polyer that are melted and blended together. It must be stretched in one direction to form alternating domains with varying refractive index. Such films are difficult to control and manufacture because the domain sizes are very sensitive to processing conditions.

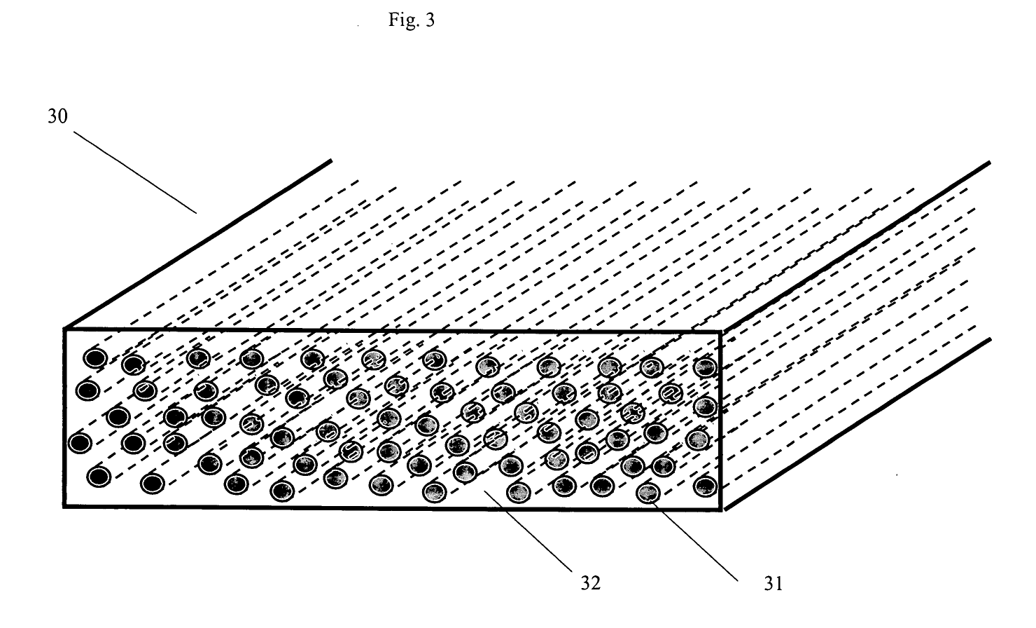

FIG. 3 is a 3 dimensional view of an inventive film with polymers domains (fibrils) 31 that have been extruded internal to the film with a continuous phase polymer 32 that has a different refractive index than polymer fibril 31. This type of film has a curvilinear domain and is processed in a separate melt extruder and extruded through separate orifices and flow channels until it in embedded within the surrounding continuous phase polymer. Domains of this type are easier to make and provide a higher degree of diffusive properties.

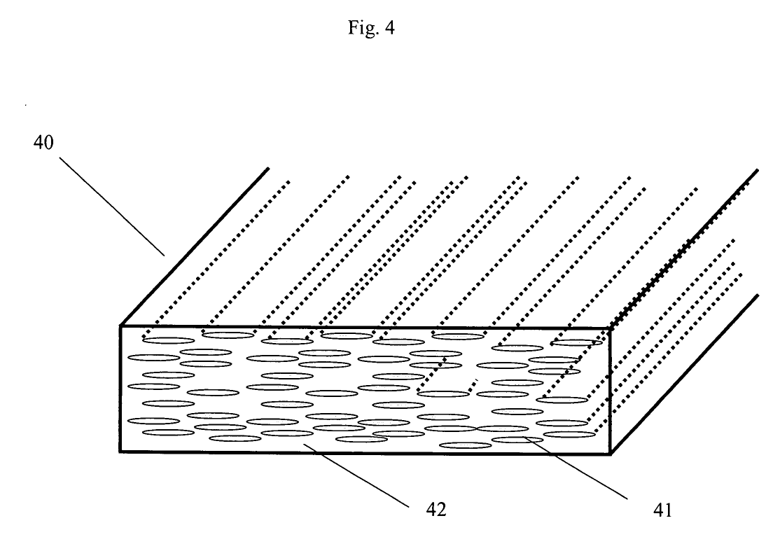

FIG. 4 is a 3 dimensional view of inventive film 40 with polymers domains 41 that are elongated ellipses and embedded internal to a continuous phase polymer 42.

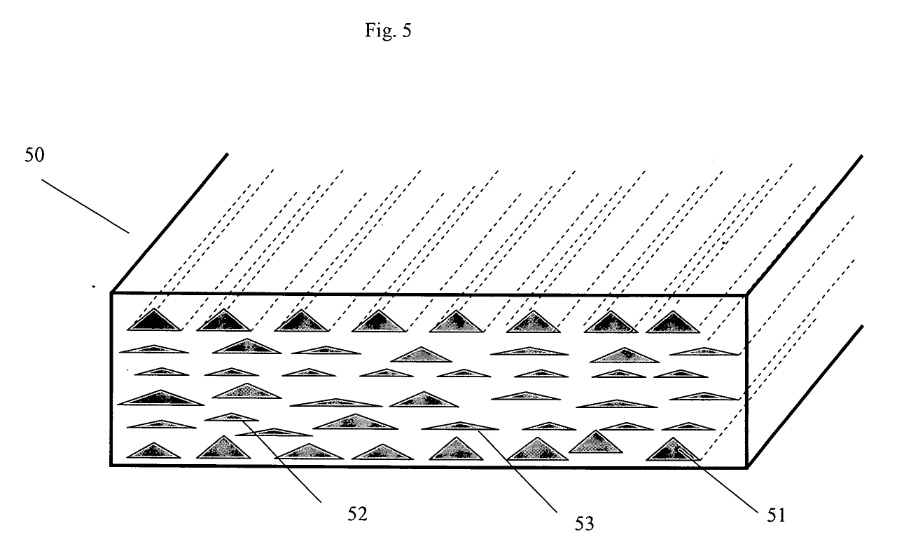

FIG. 5 is a 3 dimensional view of an inventive film 50 with polymers domains that are triangular in shape 51, 52 and 53. The size and angle of the shape may be controlled and varied to enhance optical performance. Such shapes are useful in providing a means to better collimate the light.

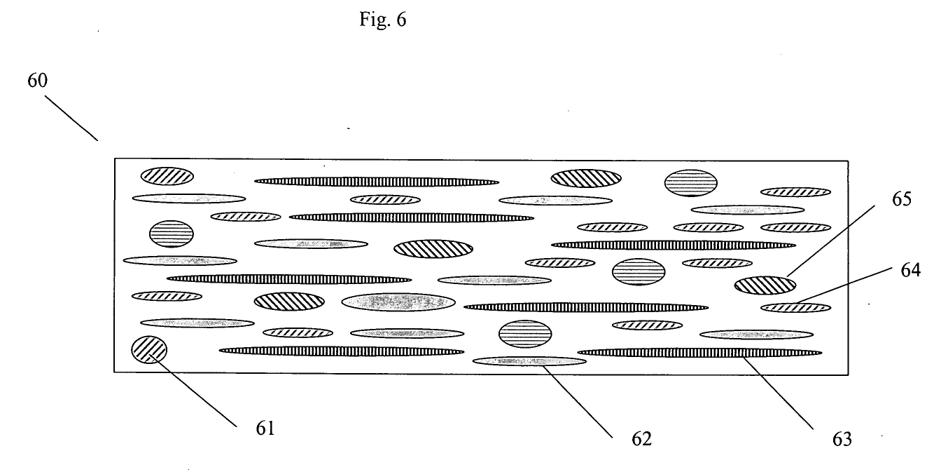

FIG. 6 is a cross sectional view of an inventive film 60 with predetermined ordered discrete polymers domains that vary in shape and dimension as shown by 61,62,63,64 and 65. Previous disclosures typically show only one type of shape in the films cross section. Processes to make both stacked layer and immiscible polymer blends domains are not capable of making more than one shape. Multiple shaped domains are useful in reducing unwanted spectral optical abbreviations. Such shapes are not limited to those that may be implied in this figure. They may be a combination of any shape and the shapes may be random or ordered in their distribution within the film.

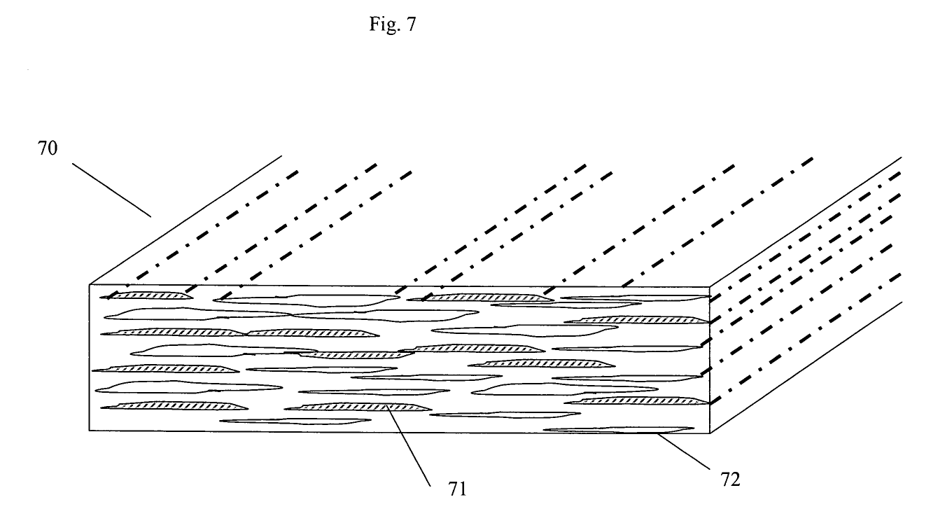

FIG. 7 is a 3 dimensional view of a reflective polarizer 70 with polymers domains 71 and 72 that have an order position within the film planes as well as a predetermined (non-random) but varying shape within its cross-sectional thickness.

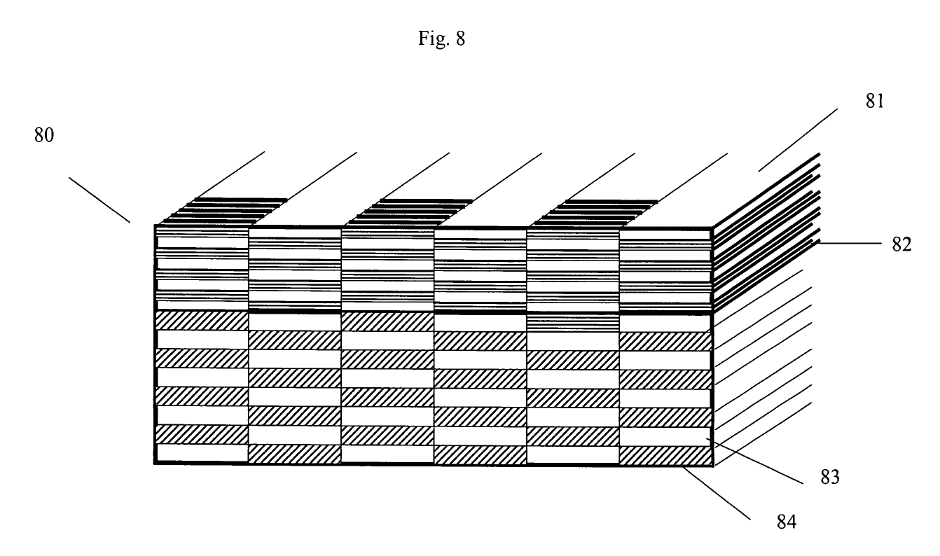

FIG. 8 is a 3 dimensional cross-sectional view of a reflective polarizer with no continuous polymer domains in its width or thickness plane. The polymer domains may run in a continuous strip in the machine direction length of the film sample. Domain 81 is a polymer of thickness A and refractive index A and 82 is a polymer domain with polymer thickness A and refractive index B. Polymer domains 83 and 84 have a thickness that is different than domains 81 and 82 but have the same respective refractive index. Such films are effective polarizer but can not be made with the traditional process used to form stacked layers or immiscible polymer blend domains. Such a structure does not have overlapping regions as certain ribbon-like disclosures.

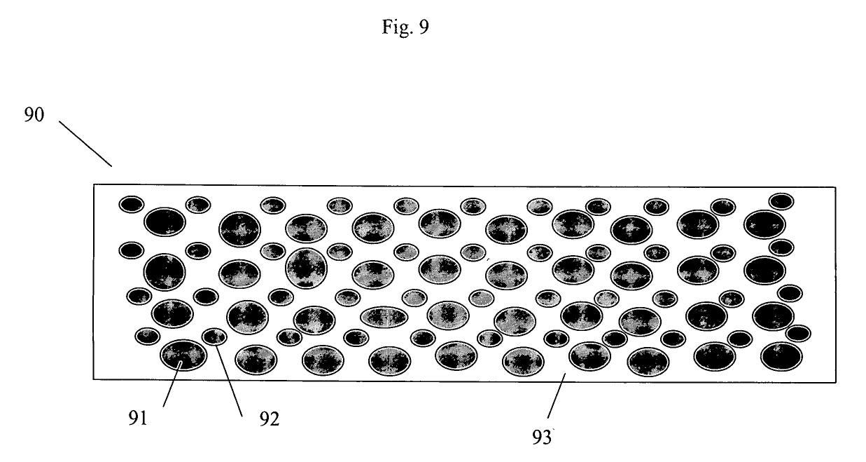

FIG. 9 is an end cross sectional view of a reflective polarizer 90 with predetermined circular to slightly oval shape ordered discrete polymers domains 91 and 92 in a continuous phase polymer 93. Such a mixture of two or more shapes that are similar to each other provides a means to efficiently reflective one phase of polarized light. Such film require less thickness and optical interfaces to provide good polarization.

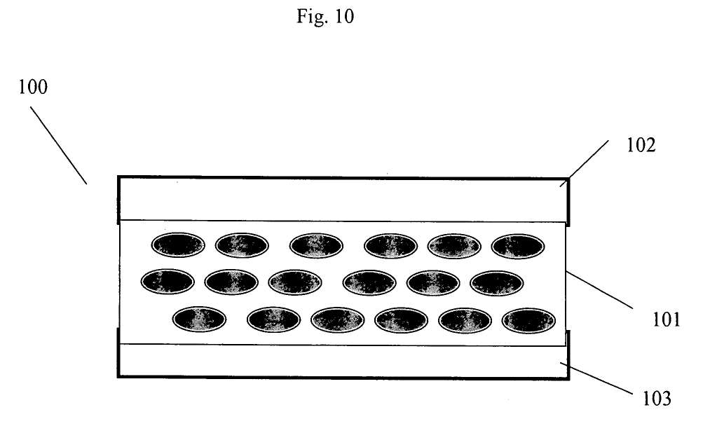

FIG. 10 is a cross-sectional view of a multi-layer reflective polarizer 100 with polymer skins 102 and 103 and with predetermined ordered discrete polymers domains 101 that have an order position in the core layer. The polymer skins may be added for improved stiffness, dimensional stability as well as a means to protect the polarizing layer. One or more of the skins may be removal or one or more may further comprise a means to diffuse light. Such a films would potentially provide both transmitted and reflective polarized light.

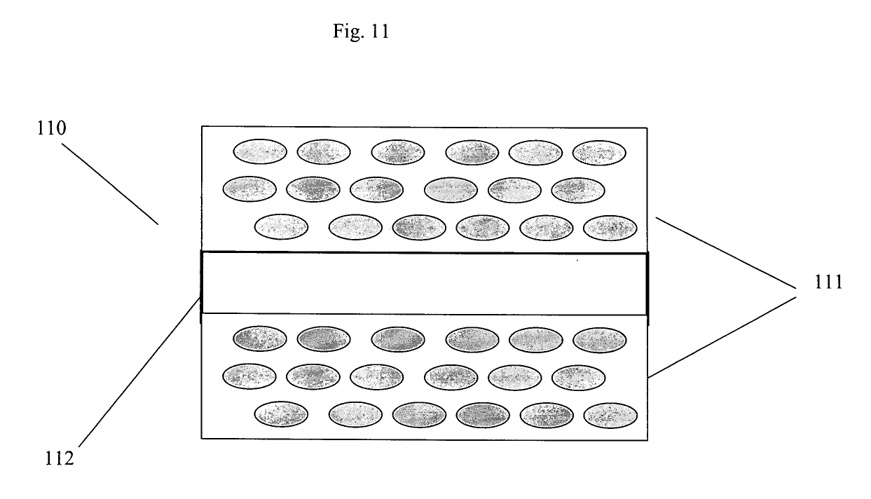

FIG. 11 is a cross-sectional view of a two layer reflective polarizer 111 with polarizing layers 111 and clear layer 112. Providing films with at least two polarizing layer provides a means to manufacture thin polarizing layers. Adding more than one layer would help to improve the efficient of the polarizing film. This process could be done as a single coextrusion process or a lamination step. Such processes and resulting films can provides an improved means to control the number of layers to tune the amount of transmission and or reflection.

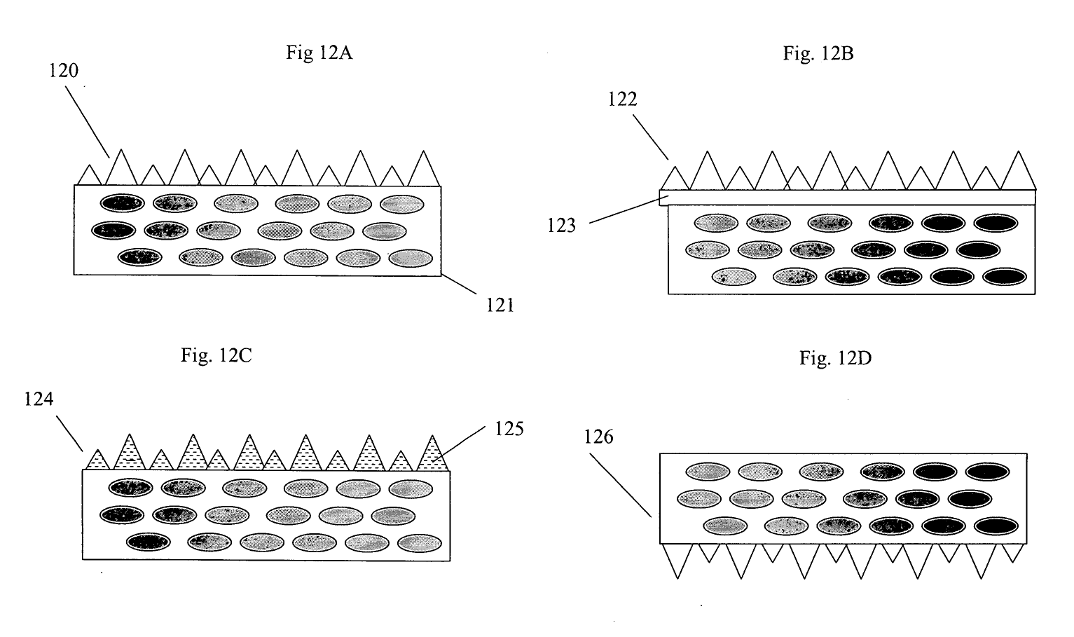

FIGS. 12A, 12B, 12C and 12D are cross sectional views of a reflective polarizer with second polymeric material shapes 121 with a patterned surfaces 120, 122, 124 and 126 respectively. The pattern may be individual elements or any desired design including symmetrically and asymmetrically but not limited to this, continuous channels, uniform or varying density, rough or smooth surface. The apex and or valley may be sharp, rounded, blunt, truncated or contain more than one angle. The patterned polarizer may provide one or all function for light columniation, light extraction, spectral or diffuse. The pattern feature may contain polarizer elements 125 internal to the feature as show in FIG. 12C. The features shown in FIG. 12B may have been preformed on a separate film 123 and attached to the reflective polarizer. FIG. 12D shows the feature on the opposite side of the reflective polarizer. Such films are useful in helping to add more than one functionality to the film. The micro-structures may be used to add collimating to the entering or exiting light. This is useful in reducing the total number of film and helping to reduce the total thickness of the film stack used in displays.

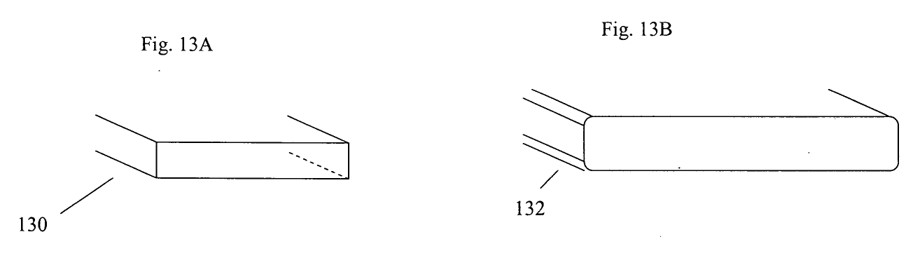

FIGS. 13 A, and B show a typical 3D cross section of a ribbon-like structure 130. FIG. 13A is a ribbon shaped feature while FIG. 13B is a ribbon-like shape with rounded corners 132. Ribbons and ribbon-like features are thin flat features with at least 2 major surfaces that are parallel to each other and two minor surface that are parallel to each other and are perpendicular to the major surface. In general the surface of a ribbon is smooth.

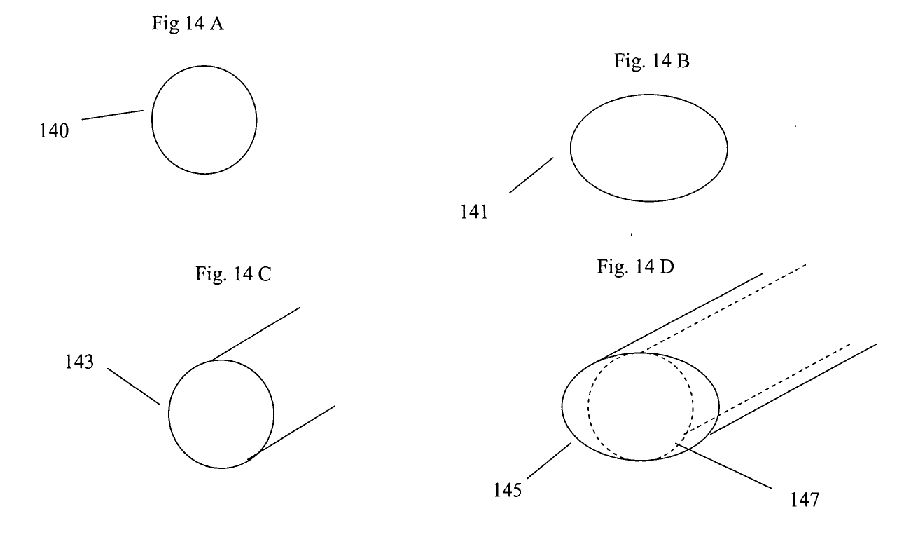

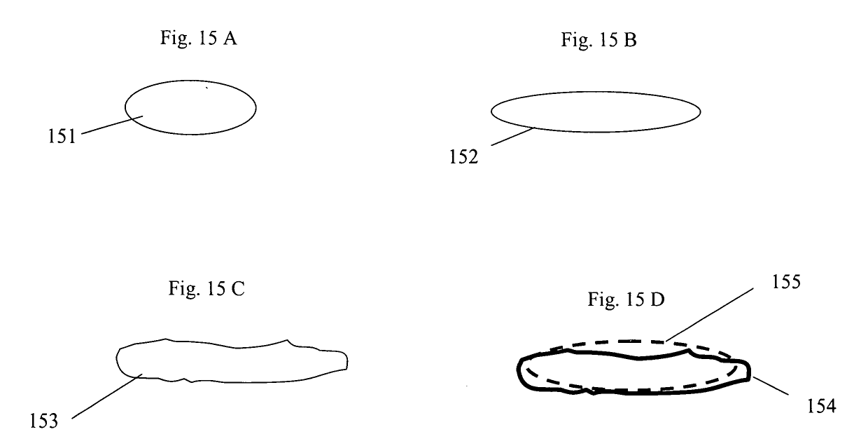

FIGS. 14 A, B, C and D are a cross-sectional view of cylinders and cylinder-like predetermined domains. FIG. 14 A is a circular cylinder shape 140, while FIG. 14 B show a slightly elongated cylinder shape 141 while FIG. 14 C provides a 3D cross-section view of a cylinder shape 143. FIG. 14 D provides a 3D cross-section of a slightly oval cylinder-like shape 145 with a cylinder projection 147. FIGS. 15 A, B, C and D are end cross-sectional views of oval shapes fibrils. FIG. 15 A is a classical oval shape 151 to near egg shape. FIG. 15 B is an elongated oval shape 152, while FIG. 15 C is an irregular shaped elongated oval-like shape 153. FIG. 15 D provides an elongated oval-like shape projected 155 over an irregular elongated oval-like shape 154. Some irregular shapes may be formed as the interfacial tension or melt viscosities of the two phases are changed. Hot spots within the extrusion process and or frictional drag near equipment walls may create non-ideal shapes.

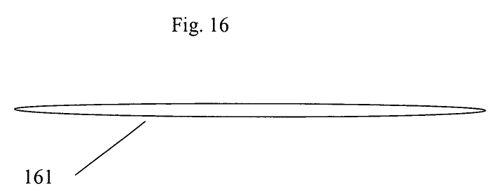

FIG. 16 is a plate-like shape 161 (fibril). While it appears to be oval-like it typically much wider and only has two surfaces that are irregular in shape and forms blunt to sharp point of the ends

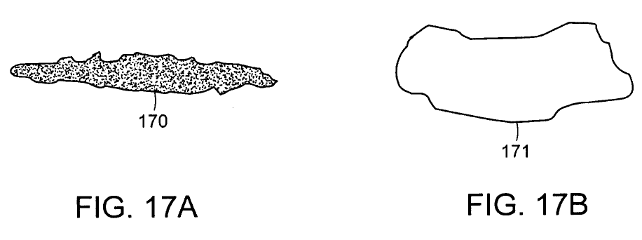

FIG. 17 A is an irregular shape fibril 170. FIG. 17 A has not major flat surfaces and FIG. 17 B is another irregular shape fibril 171 also has no flat surfaces but does not appears to be a ribbon-like, cylinder-like or oval-like.

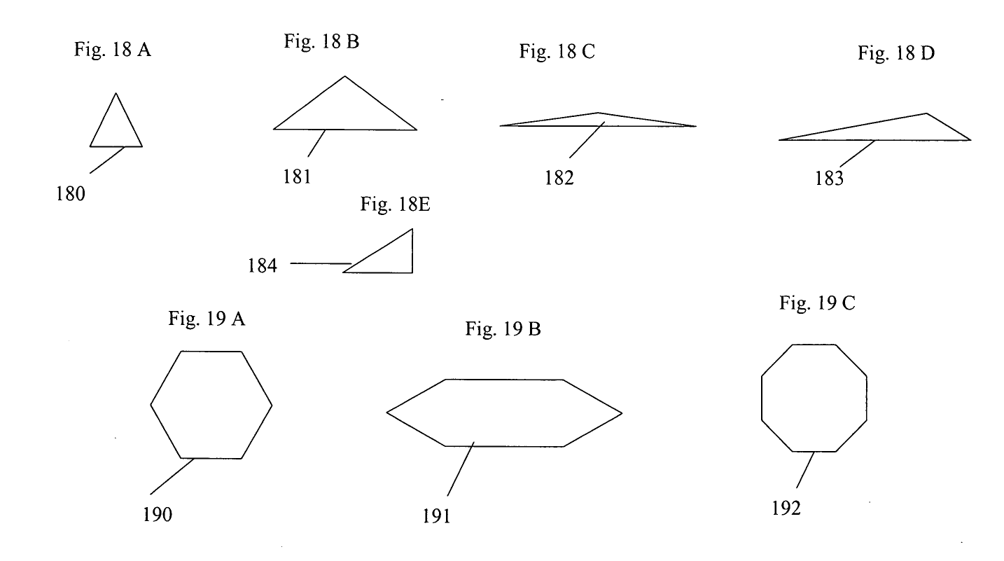

FIGS. 18 A, B, C and D are all end cross-sectional view of triangular and triangular-like shaped fibrils (180-184).

FIGS. 19 A, B and C are rhombic polygon or multi-sided shapes 190-193 (fibrils).

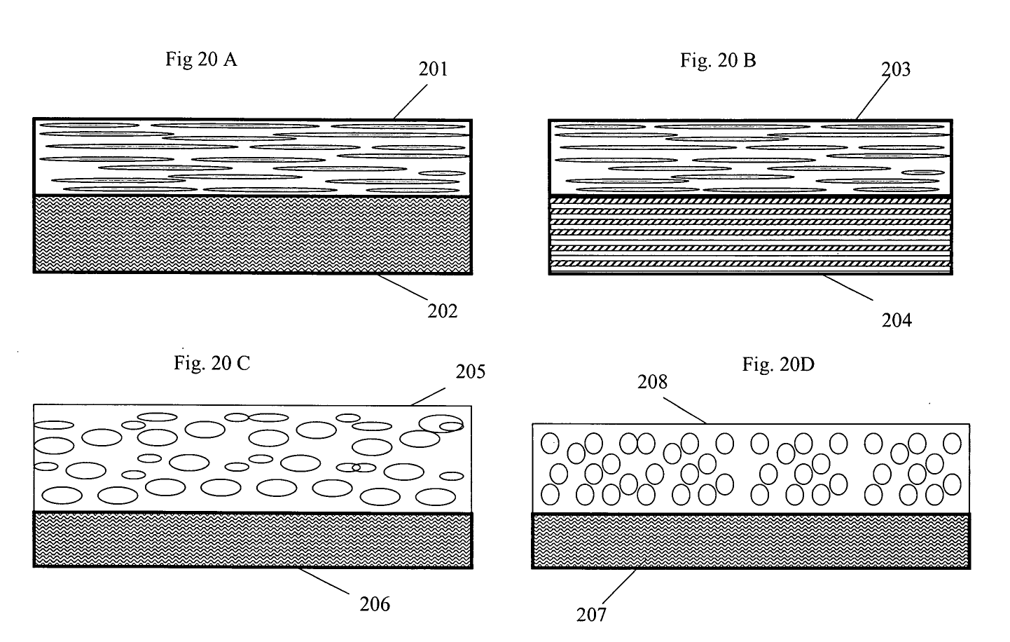

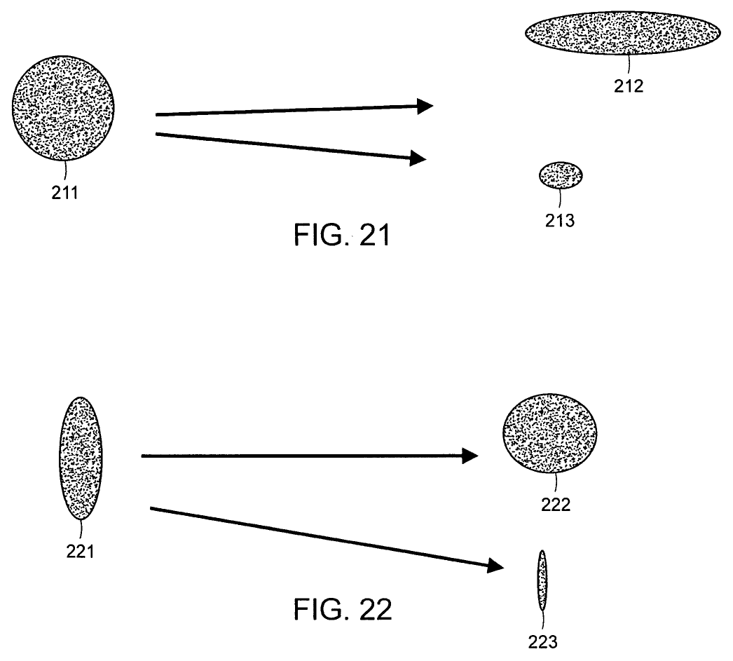

FIGS. 20 A, B, C and D is a combination reflective polarizer. FIG. 20 A is a composite of plate-like spatially predetermined continuous domains 201 with immiscible polymer domains 202. FIG. 20 B is a combination of stacked layers 204 and plate-like spatially predetermined continuous domains 203. FIG. 20 C is a composite of oval-like spatially predetermined continuous domains 205 and immiscible polymer domain 206. FIG. 20 D is a composite of cylinder-like spatially predetermined continuous domains 208 and immiscible polymer domain 207. Other potential combination of reflective polarizer is to provide a film with more than one layer using different means of polarizing the light. FIG. 21 is a cross section of a fibril 211 that is a cylinder-like shape before stretching and an oval-like shape 212 after it has been stretched in the cross direction or a smaller cylinder-like shape 213 in stretched in the machine direction or long axis of the fibril.

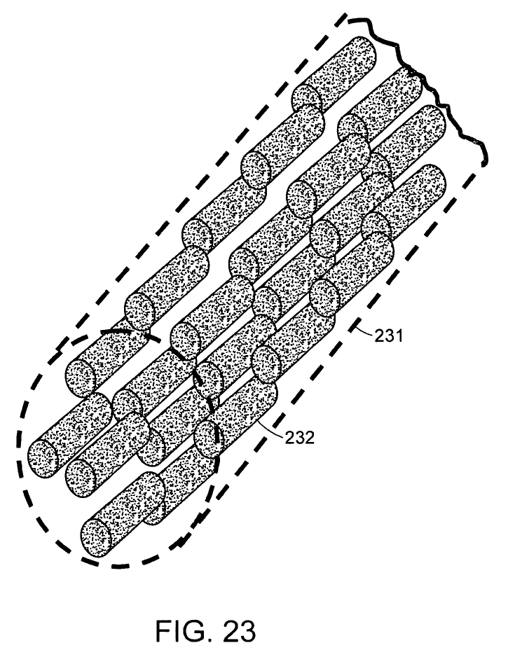

FIG. 22 is a cross section of fibril 221 with a oval-like shape before stretching and cylinder-like shape 222 after stretching in the cross direction and compressed oval shape 223 when stretched in the machine direction (long axis of the domain). Because these films are stretched to provide improved differences in birefringence or I to improve the physical properties, the starting shape is not always the sample as the intended final shape. The benefit of a process for making a multi-phase birefringent film is the shape during extrusion may be predefined to yield a desired final shape. FIG. 23 is a 3D cross section of a second polymeric material that is not continuous and disposed within the first phase 231 with discontinuous domains. By blending two or more immiscible polymers in the melt stream used to form the domain shape and then stretching the film, a non-continuous second polymeric phase material may be formed with the first polymeric continuous phase material. While this figure depicts a round or cylinder shape, the shape is only limited to the ability to the shape in the photolithography process. In other words any shape is possible. At least one of the two polymers of the immiscible blend should be birefringent. The other polymer should have substantially the same refractive index of the first phase. In other variations of this concept, both phases could have an immiscible blend of two or more polymers.

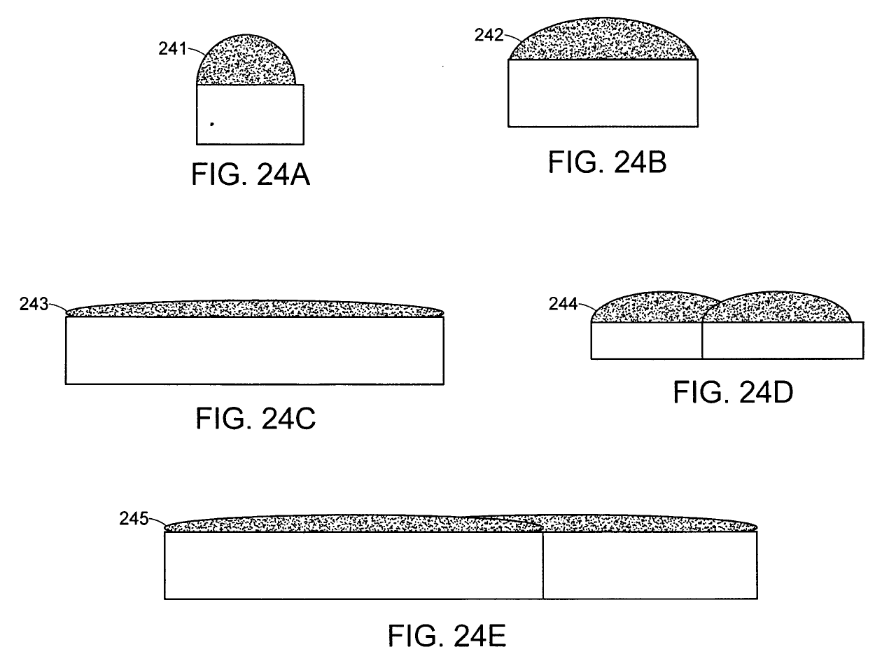

FIGS. 24A, B, C, D and E are end cross sections of partial shaped domains. FIG. 24 A is a half circle or half cylinder-like domain 241. FIG. 24 B is a half oval-like shape domain 242. FIG. 24 C is a half of an elongated shaped domain 243. FIG. 24 D is a multi-lobal shaped domain 244. FIG. 24 E is a multi-lobal half elongated domain 245. This figure provides other shapes that are possible to make to control or otherwise modify the properties of the light being transmitted or reflected from the multi-phase birefringent films useful in this invention. While there are many more shapes that can be made, the point is that this novel process is very flexible in what it can make and does not rely on the unpredictable shaped domains that are made when stretching a film where two immiscible polymers have been blended together and then stretched.

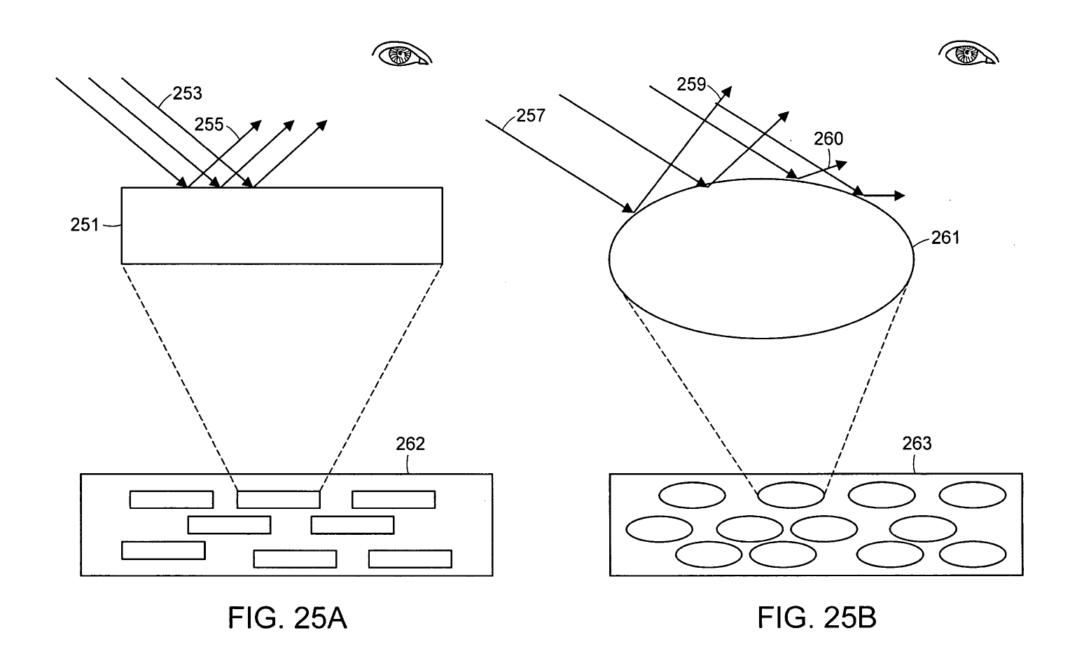

FIG. 25 A and FIG. 25 B are end cross sections of a ribbon-like polymer domain 251 and a curvilinear polymer domain 261. Both polymer domains 251 and 261 are shown is enlarged representation of a multi-lamella film 262 and multi-domain diffuse reflective polarizer 263. In FIG. 25 a incoming light rays 253 and projected on to the surface of the ribbon-like domain and are partially reflected as light ray 255 at the same incidence angle at the point where the incoming right ray 253 hits the ribbon-like surface. In general an observer would view this as predominately a spectral reflection. In FIG. 25 B incoming light rays 257 are projected on to the surface of the curvilinear domain and are partially reflected as light ray 259 at the same incidence angle at the point where the incoming right ray 257 hits the curvilinear surface. While incoming rays are reflected at the same incidence at the point of contact, the reflected rays are not parallel to each other (as a result of the curvilinear surface) and therefore an observer would integrate multiple reflected rays and see it as predominately a diffuse reflection. It should be noted that only the top layer is likely to be diffuse in FIG. 25A. As the light transmits into the second and below layers, reflection from surfaces will be reflected and some will hit the bottom of the layer above. Such multiple reflection will form a diffuse reflection.

### Article

One embodiment useful in this invention is an optical element comprising a multiphase birefringent film comprising (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction.

The above film may comprise a layer including continuous phase and discontinuous phase materials, wherein the discontinuous phase materials comprises polymer domains and include a birefringent material having a different refractive index in the orthogonal X and Y directions in a plane perpendicular to the direction of light travel. This optical film provides improved polarizing over other films known in the art. It has a high degree of transparency to at least one polarizing stated while having high reflectance of the other polarizing state. This ability to let some light through while rejecting and then recycling light from the other polarizing state provides for improved brightness and overall light effieicency. In another embodiment the optical element useful in this invention a multiphase birefringent film comprising (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction wherein said film containing a layer including continuous phase and discontinuous phase materials, wherein the discontinuous phase materials are polymer domains and include a birefringent material having a different refractive index in the orthogonal X and Y directions in a plane perpendicular to the direction of light travel wherein said film has the diffuse reflectivity of said discontinuous phase material and continuous phase material taken together along at least one axis for at least one polarization state of electromagnetic radiation is at least about 50%, the diffuse transmittance of said discontinuous phase material and continuous phase material taken together along at least one axis for at least one polarization state of electromagnetic radiation is at least about 50%. The higher the level of transparency to the one polarizing state and the higher the reflectance of light in the other polarizing state improves the overall efficiency of the film.

In one embodiment of this invention is a shaped article with a first polymeric material forming a continuous phase in all directions and a second polymeric material that is continuous in only one direction disposed within the first phase, the second polymeric material being predominately curvilinear in its end cross sectional shape and substantially extending the length of the film, at least one of the phases being birefringent and the two phases being substantially matched in refractive index in at least one direction. Such articles may be useful in a variety of application including but not limited to lens of all type and applications as well as reflective polarizing film for use in display application

Such articles may comprises a film or sheet or lens for use in a display or other optical application. The article described may also be a multi-phase birefringent film comprising (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction. To be effective in some of these applications the relative refractive index may be between 0.03 and 0.15 in at least one optical axis. Typically the greater the difference the more effective the article is it intended application. The shaped article may be flat as in a film or sheet but may contain internal polymeric domains that have a shape. In one embodiment of this application the shape may be curvilinear in its non-continuous cross-sectional view. Embodiments may include but are not limited to ellipse-like or circular-like. In a film or sheet application, if the film is stretched in one direction it may form curvilinear shapeds that tend to be elongated.

In a further embodiment the optical element (article or multi-phase birefringent film) comprising a film is used in an LCD display. The optical element provides improved brightness by recycling light from one polarization that would otherwise be absorbed or scattering by the liquid crystals. When light from one polarization is reflected by the film it hits another surface and the subsequent light is re-polarized with both s and p state of polarization. This light re-enters the optical element of this invention and approximately half of that light is transmitted and the other half is again recycled. Therefore there is a net gain in the overall light transmission.

The optical element as well as a diffusely reflecting polarizer embodiment of the multi-phase birefringent film that is used in an LCD display that is useful in this invention is used in combination with a variety of other film or elements such as a slab diffuser, a bottom diffuser, a light efficiency film (continuous or discrete elements), a light modulating valve and a color filter array. The use in combination with one or all of these films helps to provide the proper light management for an LCD display.

The diffusely reflecting polarizer (optical element) (multi-phase birefringent film) comprise at least two materials containing a layer including a first polymeric material that is continuous in all direction and a second polymeric material that is continuous in only one direction, wherein the second polymeric material may include a birefringent material having a different refractive index in the orthogonal X and Y directions in a plane perpendicular to the direction of light travel. The relative difference in birefringence helps to improve the overall performance of the film for polarization recycling. The optical element useful in the embodiment in this invention may have a refractive index of the continuous phase in the X and Y directions within 0.02 of each other.

Some materials that are useful in this invention for the said a first polymeric material forming a continuous phase in all directions (continuous phase) may include from the group consisting of polyester, an acrylic, or an olefin and copolymers thereof. The continuous phase (first polymer) comprises polyethylene(terephthalate), poly(methyl-methacrylate), poly(cyclo-olefin), or and copolymers thereof. Additional embodiments may include poly(1,4-cyclohexylene dimethylene terephthalate).

Material that are useful in this invention for the second polymeric material comprises polyester and more specifically the polyester may comprises polyethylene(terephthalate), polyethylene(naphthalate), or a copolymers thereof including but not limited to polyethylene(terephthalate) or polyethylene(naphthalate).

The optical element useful in this invention that forms a diffusely reflecting polarizer wherein the discontinuous phase materials that has a melting temperature different than the melting temperature of the polymeric continuous phase. By providing a melt temperature difference, a process of melt fusing may be used in the course of fabricating the optical element. Polymer domains that are useful in this invention may have discontinuous phase materials and a surrounding sea polymer as a continuous phase wherein the phases include birefringent material having a different refractive index in the orthogonal X and Y directions in a plane perpendicular to the direction of light travel. In a process of making the optical elements in this invention where heat is applied, the outer sea polymer (first polymeric material) may be adjusted in it degree of birefringence by heating it near it melting point. The crystal structure in the polymer is dissolved and therefore the birefringence difference may be adjusted. This is useful because it allows various materials to be used that otherwise would not provide sufficient polarization to be useful in an LCD display.

In one embodiment, the number of r polymer domains in said mutli-phase birefringent polymeric film is at least 50 in its cross-sectional thickness and in a further embodiment the number of second polymeric material shapes is between 200 to 1200. and in yet another embodiment, the number of second polymeric material shapes is between 300 to 700. Being able to control and adjust the number of polymer domains provides a means of being able to tune the resulting optical element to the amount or degree of polarization within the electromagnetic spectrum. Another useful control point is to control the size and geometry of the polymer domains as well as the spacing between them.

The multiphase birefringent films of this invention are a diffusely reflecting polarizer film comprising a film wherein said film has the diffuse reflectivity of said discontinuous phase material and continuous phase material taken together along at least one axis for at least one polarization state of electromagnetic radiation is at least about 50%, the diffuse transmittance of said discontinuous phase material and continuous phase material taken together along at least one axis for at least one polarization state of electromagnetic radiation is at least about 50%. Such a diffusely reflecting polarizer film comprises at least one layer comprising polymeric spatially predetermined domains that comprise discontinuous phase birefringent dispersed in a polymeric continuous phase polymer; wherein said second polymeric material form multiple overlapping regions with at least adjacent domains. The second polymeric material are substantially parallel to within 0 to 10 degrees of each other within the same cross sectional slice along the film length.

The diffusely reflecting polarizer films useful in this invention has a figure of merit (FOM) of at least 1.2. Such film provide at least light reflection of at least 50%.

In other embodiments the multiphase birefringent film comprising (a) a first polymeric material forming a continuous phase in all directions and (b) a second polymeric material that comprises an immiscible blend of at least two polymers wherein at least one of said at least two polymers is substantially matched in refractive index in at least one direction to said first polymeric material wherein said a second polymeric material is non-rectilinear (ellipsoidal/curvilinear/oval) in shape. The second polymeric material that comprises an immiscible blend forms non-continuous fibrils in the length direction.

The optical element comprising useful in the embodiments of this invention may have shaped polymer domains each with a cross sectional area of less than 3 square microns while other embodiments have polymer domains where the cross sectional area of between 0.5 to 3 square microns. In yet another embodiment, the optical element comprises polymer domains each with a cross sectional area between 0.6 to 1 square microns. Other embodiments of this invention may have a variety of polymer domains with different cross sectional area. Other embodiments may have a variety of shapes and sizes. Increased number of interface will result in improved reflection while few interfaces will improved the transmission of the resulting optical element. To provide the optimal film for reflective polarization the number, the size and shape of the polymer domains need to be balanced as well as the selection of materials and the resulting process to make the optical element need to be adjusted to control the ordinary refractive index for transmission properties and the extraordinary refractive index for reflective properties.

The multiphase birefringent film embodiments that are useful in this invention have each individual domains having a cross-sectional thickness of between 90-1500 nm and in other embodiments each individual domain has a cross section thickness of between 400-800 nm. Such films have a good balance between it transmission and reflection properties of their respective polarization phase of light.

The multi phase birefringent film useful in this invention is oriented (stretched) in at least one direction while other embodiments may be oriented in the machine direction and yet others oriented in the cross machine direction.

In other embodiments that are oriented in both direction the orientation may be in one direction that the other or simultaneously.

The multiphase birefringent film that are useful in this invention have a first polymeric material forming a continuous phase in all directions that is isotropic. In other embodiments the first polymeric material forming a continuous phase in all directions is birefringent while in other embodiments the second polymeric material that is continuous in one direction disposed within the first phase is isotropic and in yet other embodiments the second polymeric material that is continuous in one direction disposed within the first phase is birefringent.

To provide good optical performance a preferred embodiment of this invention has a multiphase birefringent film wherein said a second polymeric material has a packing density of between 0.7 to 2 features per square micron within the said a first polymeric material forming a continuous phase in all directions. The number of optical interfaces of the multi-phase and the process of making provides a balance between the reflection and transmission properties of each polarization phase of light. Such films and process provide a second polymeric material comprises at least 50 to 250 optical interfaces in the thickness dimension of the film. In other useful embodiments the process provides a multi-phase film wherein said second polymeric material comprise at least 250 to 500 optical interface in the thickness dimension of the film. In other embodiments of the film and process the film as well as the process a second polymeric material comprise at least 500 to 1000 optical interfaces in the thickness dimension of the film and still other there are at least 1000 optical interface in the thickness dimension of the film. Increased number of optical interface provides film with improved reflective properties. For the purpose of this patent a polymeric domain has two primary optical interfaces, one where light enter the domain and one where in exits the domain.

The multiphase birefringent film comprising with a first polymeric material forming a continuous phase in all directions and a second polymeric material that is continuous in only one direction disposed within the first phase, the second polymeric material being predominately triangular in shape and substantially extending the length of the film, at least one of the phases being birefringent and the two phases being substantially matched in refractive index in at least one direction. The multiphase birefringent film may also have triangular shape comprises fibrils that are useful in directing and collimating light.

In the embodiments of this invention that have a curvilinear shape domain, the domain has a width to height aspect ratio of between 10 to 1 and 0.1 to 1 while others have a width to height aspect ratio of between 6 to 1 and 1 to 1. Such shapes are useful in provides the correct amount of transmission and reflection. The curvilinear shape domains may be a combination of at least two shapes selected from the group consisting of circular-like, oval-like, ellipse-like. Having more than one shape to the polymeric domains is useful in providing film with a good balance between their transmission and reflective polarization properties. Such a mix of shapes provides films that are free of color abbreviations.

In useful embodiments in this invention the ratio of discontinuous phase to continuous phase on a weight basis is less than 2 to 1. Higher amounts of discontinuous phase material in the polymer domains will increase the resulting films reflection. In other embodiments where increasing transmission is desired the ratio of discontinuous phase to continuous phase on a weight basis is less than 0.8 to 1 and in these case where even higher transmission is desired the ratio of discontinuous phase to continuous phase on a weight basis is less than 0.3 to 1.

The shape or geometry of the polymer domains that are use to make some of the embodiments of this invention are useful tools to help optimize the transmission and reflection properties of the optical element. The optical element may comprise polymer domains as the discontinuous polymeric phase that have a cross-sectional shape that is circular, elliptical, triangular, tri-lobal, or trapezoidal. Circular (radical) shaped second polymeric material may tend to collimate light, elliptical shapes are useful in spreading light in a slightly wider angle.

In the formation of the optical element useful to provide reflective polarization, the polymer domains are aligned to be substantially parallel in relation to each other. In some embodiments the polymer domains are parallel to each between 0 to 20 degrees. Zero degrees refers to the fact that they are parallel. in other embodiments the polymer domains are between 0 to 10 degrees and in the most preferred embodiment the predetermined polymer domains are parallel form 0 to 5 degrees.

### General Process Disclosure for the Article

The optical element of this invention may be formed by a number of processes including but not limited to:

Film Making

The process for making a multiphase birefringent film comprising (a) a first polymeric material forming a continuous phase in all directions and (b) a second polymeric material that is continuous in only one direction disposed within the first phase, the second polymeric material being predominately curvilinear in shape and substantially extending the length of the film, at least one of the phases being birefringent and the two phases being substantially matched in refractive index in at least one direction comprising the steps of:
i) forming said film by a melt extrusion process
ii) casting said film onto a surface that is at a temperature below the polymer melt temperature
iii) stretching said film in at least one direction at a temperature above the Tg of the continuous phase polymer to change the birefringence of the second polymeric material
a) iv) heat stabilizing the film. The refractive index of the first polymeric material forming a continuous phase in all directions in in its X and Y directions are substantially matched. There should be at least a 0.02 or greater difference in refractive index between said first polymeric material and said second polymeric material. An extra but not necessary step of heat processing the film may be useful in allowing the continuous phase first polymer to change in the amount of its birefringence in relation to the birefringence of the polymer domains. If this step is utilized the extrusion melting temperature of the continuous phase is less than the onset melting range of the polymer domains. Such a method is useful in providing a broader range of polymers that may be used in making film useful in this application. Whether this step is used or not, the extruded film is then stretched in at least one direction. The film may be stretched in the cross direction which is useful in changing the relative shape of the extruded discrete polymer domains. Such a stretching will elongate the shape and narrow their cross sectional thickness and relative spacing between domains. The stretching is also useful in increasing the birefringence of the domain polymer. Stretching in the machine direction will also change the domain cross sectional thickness and their birefringence. Stretching in both direction is also useful in helping to tune the size, and shape of the domains as well as providing a film that is more dimensional stable. Stretching in both directions may be dome one after the other or may be done simultaneously. Simultaneously stretching is useful in providing a film with polymer domains that have two of three optical axes that are matched with each other as well as the surrounding continuous phase in their refractive index. This helps top provide improved transparency of the film as well as its overall ability to function as a reflective polarizer.

In another process for making a multiphase birefringent film the process of comprises providing:
i) a means to dry polymers separately or together
ii) a means of feeding the polymers
iii) two or more separate extruders or melt pumps so each polymer is melted, metered and pumped separately
iv) a series of orifice/flow plates that forms the second polymeric material that comprises a shape
v) a means of encapsulating the second polymeric material within the first polymeric material polymer
vi) a means of dividing the polymer flow and repositioning it either as a vertical stack or horizontal adjacent to the master flow.
vii) a means of directing the polymer flows into a die
viii) a means of casting the molten polymers onto a quenching device (temperature controlled roller(s), moving belt, calendar rolls)
ix) a means of imparting surfaces onto the cast film
x) at least one means of stretching the cast film in at least one direction at or near the Tg of the continuous phase first polymer.
xi) a means of heat stabilizing the film
xii) a means of winding the film into a roll or means of sheeting the film.

Diffusely reflective polarizer films produced as described above can be used in liquid crystal displays (LCD's) to more efficiently utilize light emitting from a backlight system. Although the placement of the diffusely reflective polarizer is not limited it typically is placed between the back light unit and the liquid crystal panel comprising liquid crystal polymer between two absorptive polarizers.

In order to make the polymer domain films of the present invention effective as a reflective polarizer it is desirable to create many small domains such that many more optical interfaces can be created in a given thickness of film when dispersed by the process of the present invention into a composite film. Domains thickness that are in the size range of the wavelength of light are desirable. Since this process provides a film that does not have domains that are continuous layers (width dimension), the resulting films do not suffer from a color bias due to optical interference. Typically structures that have a highly controlled and regular spacing between layers are highly spectural and can suffer from optical interfence. The resulting films are crystal clear and therefore more desirable. For LCD TV and other viewing applications films that absorb light in one region of the visible spectrum can result in an image that is biased in its color replication therefore creating a false image. By forming polymer domains of a second polymeric material that are continuous in only one direction, the color interference problem is eliminated. The cross sectional shape of the polymer domains can be of any geometry such as circular, elliptical, triangular, tri-lobal, or trapezoidal. Again, typically the polymer domains cross sectional shape will be circular or elliptical with the most common cross sectional shape being circular.

The polymer domains in the films of the present invention can comprise any polymer in the general class of polyesters. Typical polyesters for such use can be polyethylene(terephlatate), polyethylene(naphthalate), or any copolymers of either. The most suitable polyester for the polymer domains is polyethylene(terephlatate).

The continuous polymeric phase in the film comprising polymer domains of the present invention can comprise any polymer in the general classes of polyesters, acrylics, or olefins. Typical polymers for such use can be polyethylene(terephlatate), poly(methyl-methacrylate), poly(cyclo-olefin), or any copolymers of either. The most suitable polymers for the continuous phase is poly(1,4-cyclohexylene dimethylene terephthalate) or poly(ethylene-terephthalate/isophthalate) copolymer.

As mentioned previously the extrusion melting temperature of the continuous polymeric phase of the polymer domains should be less than the onset melting temperature of the polymer domains s. Typically this difference will be greater than 10 C but is preferred to be greater than 40 C. Most preferably the extrusion melting temperature of the continuous polymeric phase is greater than 75 C below the onset melting temperature of the birefringent polymer domains.

The film with polymer domains drawn after being melt extruded as is typical for such a process. The cold stretch is done with the film heated to just above the glass transition temperature(Tg) of the polymer domains s polymer. Typically the cold stretch is done at 2 to 20 C above Tg.

The amount of stretch or stretch ratio, which is the ratio by which the film is lengthened relative to its initial length (or width), is important in attaining a high level of birefringence of the either the continuous phase or in the polymer domains. This is important as it creates a large difference in the Z direction (see FIG. 2) extraordinary index of the domain (discontinuous) phase and the eventual Z direction ordinary index of the continuous phase of the composite film. The Z direction of the continuous phase is melt relaxed during film processing and therefore retains the ordinary index of the continuous phase polymer resulting in an isotropic continuous phase. The large difference in Z direction index of the domains and the continuous phase is desired as it results in a high degree of reflection of light that passes through the film that is approaching the film orthogonal to the film surface and is linearly polarized parallel to the length of the polymer domains. The stretch ratio should be greater than 2 to 1 and preferably greater than 3 to 1. Most preferably the draw ratio is greater than 3.5 to 1 to maximize the degree of crystallinity and thus birefringence of the polymer domains.

The continuous polymeric phase may also become birefringent in the stretching process but this is not critical. Any birefringence of the continuous phase polymer may be eliminated during a subsequent heat relaxation of the composite polarizing film. Therefore stretching temperature is only critical for the continuous phase polymer to the degree that the polymer will stretch at the draw temperature without cracking and/or sticking to the draw rollers.

As mentioned previously, a large number of smaller polymer domainsis preferable as this will ultimately result in many more optical interfaces in the final composite film reflective polarizer. The number of domains is determined by the design of the extrusion flow pack. For a given extrusion flow pack design the size of the polymer domains is then determined by the relative weight ratio of discontinuous polymer to continuous phase polymer when melt extruding. Typical weight ratios of discontinuous polymer to continuous phase polymer is less than 2 to 1 and preferably less than 0.8 to 1. Most preferably the weight ratio of polymer domains polymer to continuous phase polymer is less than 0.3 to one.

Materials of a second polymeric material that is continuous in only one direction disposed within the first phase polymer domains:

There are at least two materials: there is a first polymer (continuous phase in all directions) and a second polymeric material that is continuous in only one direction disposed within the first phase polymer. The materials have a delta birefringence and or refractive index from each other at the time of film making. The polymer domains are surrounded by a continuous phase polymer. The materials have a delta melting point within the domains material having a higher melting point. The materials have a high degree of transparency and also have a high degree (>80%) of clarity (low or no haze). The polymer domains may have any shape desired.

The cross-sectional size of the a second polymeric material that is continuous in only one direction disposed within the first phase polymer (domains) may be from 100-1000 nm. The space separating the polymer domains may be from 100-2000 nm. The domains are essentially continuous in their length dimension. If the domain polymer is in a blend of more than one polymer and in particular an immiscible blend, it is possible to have the length dimension of the domain that is not continuous. This is useful in making short domains that have different optical properties as well as providing the opportunity for more random optical interfaces. Typically, the polymeric films with polymer domains have a ratio of discontinuous phase to continuous phase on a weight basis is less than 2 to 1.

The present invention provides a process for producing a diffusive reflective polarizing film made up of a composite of birefringent polymeric polymer domains dispersed in an isotropic polymeric phase. The polymer domains are created by producing multicomponent films with a second polymeric material that is continuous in only one direction disposed within the first phase r (polymer) domains whereby the polymer domains are only continuous polymeric domains in their length direction but in a cross sectional view are considered as a discontinuous phase and wherein the refractive index of the continuous phase in the X and Y directions are substantially matched and wherein the extrusion melting temperature of the continuous phase is less than the onset melting range of the discontinuous phase.

The second polymeric material that comprise the birefringent discontinuous phase are substantially parallel to each other and dispersed in a polymeric continuous phase first polymer are polarizing. The relative degree of polarization is impacted by the relative difference in birefringency between the discontinuous phase domains and the continuous phase surrounding polymer. In one embodiment the second polymeric material is birefringent and the surrounding sea (continuous phase) polymer (the polymer that the second polymer domain are dispersed in) is isotropic. After extrusion, the film is stretched in at least one direction. The stretching process can further enhance the birefringence of the domains but may or may not induce some birefringence in the surrounding sea polymer. In another embodiment of this invention the surrounding sea polymer is a negatively birefringence material. In other words the birefringence decreases upon stretching resulting in a larger difference between the continuous and discontinuous phase. In other embodiments useful in this invention the discontinuous phase second polymeric material shapes are isotropic and the surrounding sea polymer is birefringent. In other embodiments of this invention where the second polymeric material shapes are birefringent and the surrounding sea polymer (continuous phase) is a polymer with some degree of birefringence and is the sea polymer is lower in its melting point than the polymer used to form the second polymeric material shapes, the film can be heat processed to relax the birefringence of the continuous phase and therefore create a film that has a larger difference in the birefringence between the discontinuous and continuous phases and therefore enhance the film's polarization properties. While the polymeric films useful in this invention may have some limited polarizing by themselves the methods used in this invention are useful in converting the continuous phase polymer from a birefringent material to a material that has little or no birefringence and therefore making a high efficient reflective polarizer. The process of heat processing the film provides a means of tuning the birefringence of the continuous phase material in relation to the discontinuous phase material. This process tuning provides a means to maximize the difference between the discontinuous and the outer continuous phase. The isotropic polymers useful in this invention are preferable substantially non-birefringent. In some embodiments, the isotropic polymer suitably have a refractive index difference less than 0.02. Having properties in this range makes the isotropic polymer substantially invisible.

Useful polymers for the discontinuous phase birefringent phase include polyester. The polyester may comprise polyethylene(terephthalate), polyethylene(naphthalate), or a copolymers thereof. The use of these and other materials in the polymer domains s provides a high degree of birefringence and high refractive when they are stretched. These polymers provide excellent materials for film and domain formation because of their high tensile strength during elongation. They are also relative inexpensive and are commercially available. The continuous phase of the multi-phase birefringent films (sea polymer) may suitably comprise at least one material selected from the group consisting of polyester, an acrylic, or an olefin and copolymers thereof. These materials include but are not limited to polyethylene(terephthalate), poly(methyl-methacrylate), poly(cyclo-olefin), or and copolymers thereof. One preferred embodiment continuous phase comprises poly(1,4-cyclohexylene dimethylene terephthalate).

In the selection of a material for the continuous phase polymer there may be a difference in relative melt temperature between the continuous and the discontinuous phases.

In another embodiment of this process, additional polymer may be added to either the top surface and or the bottom surface. The addition of a polymer skin is useful because it will help to provide a smooth level surface and therefore reduce unwanted light scattering as well as provide addition strength and stiffness to the continuous solid film. In a preferred embodiment, the polymer skin has an index of refraction that matches the continuous phase of the polymeric film with second polymeric material shapes. The polymer skin may also have a high degree of transparency unless the polymer in some embodiments or may be diffuse (volume or surface diffuser), or may have a structure or rough surface. The thin polymer skin comprises at least one layer but other layers or features may be added to enhance the overall functionality of the composite film. The polymer skin may have a thickness of between 6 to 400 micrometers and may be applied to either or both the top and bottom surface of the continuous solid film of this invention. It should also be noted that polymer skin may not be detectable after being attached to the continuous solid film. Furthermore it should be noted that a different skin with different properties may be added to either the top and or bottom surfaces of the continuous solid film of this invention. Such skins may be applied by melt extrusion, melt or solvent casting, lamination of a preformed polymer skin and or coating or printing a polymers layer. The polymer skin or sheet forms an integral part of the continuous solid film with second polymeric material domains. While the term polymer skin may infer a continuous layer, additional embodiments may have stripes, discrete and continuous features or non-continuous area of skin polymer. The surface of the continuous solid film and or the polymer skin may have treatments and or primer applied to enhance the overall performance and environmental stability of the final product. Addenda may be added to the skin layer (internal or surface) to enhance light and heat stability, light control such as antireflection, diffusion, collimation or spread of the light either entering or leaving the continuous solid film of this invention. The addenda may be either organic or inorganic.

As described above additional materials, features . . . etc may be added to the polymer skins. In an additional embodiment a polymer skin may be laminated to the polymeric film using a performed layer. The application of heat may be by direct contact to hot rollers or belts, hot gas blown on he surface, radiant heater, infra-red, microwave, ultrasonic radiation and other methods know in the art. As mention above the use of pressure and in particular pressure applied with a smoother surface will aid in the formation of a density, smooth film. If the film is heated on a surface such as a drum or roller, it may be desirable to have the surface of such material to be very smooth so as to provide a smooth surface to the resulting film. The rollers or belt surface may be modified with a release aid (such as Teflon or silicone) so the polymer does not stick to the surface. The temperature of that surface may also be modified to aid in the release and not sticking of the molten polymer to the roller or belt surface. In other embodiments the roller, belt or form may have its physical surface modified to prevent sticking. Such surface modification may involve roughening or creating micro-surface features. The form, roller and or belt may be temperature controlled to aid in quenching the polymer surface as well as in the release of the polymer form the surface.

In the process for making a diffusely reflecting polarizer that comprises multiphase birefringent films that comprise a discontinuous phase second polymeric material domains substantially parallel to each other and dispersed in a polymeric continuous phase, the polymeric film may comprise more than 50 second polymeric material domains. Other useful embodiments in this invention comprise more than 50 second polymeric material shapes while other comprise more than 1000 second polymeric material domains in the thickness dimension. The number of interfaces, the relative area, the shape of the domain, the relative refractive index mismatch between the polymer domains s and the continuous phase are factors that may influence the amount of transmission and reflection of light. In a general sense the few the number of interfaces, the more transmissive the film will be and the higher number of interfaces the more reflective the film. Since the optimal properties of the films of this invention are determine by a variety of complex properties of the discontinuous phase second polymeric material shapes and the continuous phase polymer it may be useful to state the second polymeric material shapes have a cross sectional area of less than 3 square microns. In those embodiments in which more transmission is desired each second polymeric material shape may have a cross sectional area of less than 0.6 square microns while in other embodiments each second polymeric material shape may have a cross sectional area of less than 0.2 square microns.

The polymeric films useful in one embodiment of this invention have a ratio of discontinuous phase to continuous phase on a weight basis is less than 2 to 1 wile other embodiments have a ratio of discontinuous phase to continuous phase on a weight basis is less than 0.8 to 1. In a preferred embodiment, the polymeric films have a ratio of discontinuous phase to continuous phase on a weight basis is less than 0.3 to 1.

In the course of making the polymeric film that are useful in the embodiments of this invention, the film is cold drawn to achieve a high level of birefringence of the discontinuous phase. The stretching process provides a degree of birefringence in both the discontinuous phase polymer domains polymers and depending on the material a degree of birefringence in the continuous phase polymer. The difference in birefringence between the two phases helps to determine the amount of polarizing that the film provides. Many polymers combinations are not sufficiently polarizing after drawing or may lack sufficient clarity. One unique part of the embodiments of this invention is that the discontinuous phase polymer birefringence is changed (lowered or eliminated) by heat processing. The birefringence of the second polymeric material domain in not altered. The remaining polymer with internal polymer domains is highly polarizing. In one embodiment the film are cold drawn at least 2 to 1. In another embodiment the process of claim 23 wherein the film have been cold drawn at least 3 to 1 and in a preferred embodiment the is cold drawn at least 3.5 to 1.

The amount of drawing that a polymer will tolerate is dependant on melt drawing properties such as its elongation to break strength. For high levels of polarizing it is desirable to stretch the polymer used in the polymer domains as much as possible to maximize its birefringence. While the continuous phase polymer will develop its own birefringence, the heat processing step will relaxed it out and the resulting difference between the continuous and discontinuous phase polymers results in a high degree of polarizing while obtaining good transmission for one polarization phase and good reflectance for the other polarization state.

In the process for making the multiphase birefringent film that are useful as reflective polarizer, the relative interfacial tension and wetting of the polymer for the continuous phase and the discontinuous phases plays a role in the actual shape of the domain. While the mechanical aspects of the orifice plates can be design to form the molten polymers to a desired shape, the relative interfacial tension of the polymers interacts with the process and will ultimately influence the final shape. Polymers in which the interfacial tensions are closely matched will take on the shape from the orifice plates better than those polymers in which the interfacial tensions are widely separated. Highly mismatched polymers will tend to form circular shapes. There is a continuum of shapes that may be obtained between those closely or widely separated polymers. The overall physio-mechanical behavior depends on two parameters. A proper interfacial tension that provides a phase size small enough to be considered as macroscopically homogeneous and an interphase adhesion strong enough to assimilate stress and strains without changing the morphology of either phase. In useful embodiments in this invention the interfacial tension difference between the continuous phase and the discontinuous phase is less than 5 dynes/cm. It other useful embodiments of this invention the interfacial tension difference between the continuous phase and the discontinuous phase is less than 10 dynes/cm. It other useful embodiments of this invention the interfacial tension difference between the continuous phase and the discontinuous phase is less than 30 dynes/cm. It should be noted that polymeric surfactants also referred to as compatibilizers may be added to either one or both polymer. Typical materials may include blocked or grafted copolymers where segments of the copolymer matches that of either or both the discontinuous and or continuous phases in the polymeric film. The copolymers may be added in a weight ratio of 0.05 to 2.percent. This range may vary depending on the degree of substitution on the copolymer. When forming reflective polarizer films with second polymeric material shapes, the relative interfacial tension difference between the discontinuous phase and continuous phase is less critical.

The process used to make said diffusely reflecting polarizer has an ER ratio of greater than 3 to 1, an FOM of >1.20 In order to make multiphase birefringent film with the desired balance in which said a second polymeric material that is continuous in only one direction disposed within the first phase and a first polymeric material forming a continuous phase in all directions (continuous phase material) taken together along at least one axis for at least one polarization state of electromagnetic radiation is at least about 50%, the diffuse transmittance of said discontinuous phase material and continuous phase material taken together along at least one axis for at least one polarization state of electromagnetic radiation is at least about 50%, the use of second polymeric material shapes is needed.

In the forming of a diffusely reflecting polarizer useful in this invention, there is at least one layer of providing polymeric fibrils that comprise discontinuous phase second polymeric material shapes substantially parallel to each other and dispersed in a polymeric continuous phase. The number of domains is dependant on the domain number, distribution, shape as well as the relative refractive index difference between the continuous phase and the non-continuous phase. In some embodiments having more than one layer is useful in assuring that there is sufficient number of domains to assure complete coverage across the width diffusely reflecting polarizer. In the extrusion process for making second polymeric material shapes there may be areas between domains that effectively creates a “void or hole” in the polarization effect. This is not be a physical hole but an area that has a reduced number of domains and therefore causes a change in the polarization effect. Such area may occur as a result of flow channels being plugged. To minimize this effect it is desirable to provide more optical interfaces that are need to achieve the minimum polarization effect. Other means that are useful embodiments in this invention is to provide at least two layers with second polymeric material shapes. Such layers may be fused, laminated or otherwise joined together. It may also be desirable to provide a separation layer of a polymer between the polarizing layers.

In other embodiments in which there is a first and at least a second or more layer, the first polarizing layer may have a different type of second polymeric material shape than the second polarizing layer. This may include but is not limited to the physical geometry of the domain, the size, shape, distribution and material of the continuous and or the discontinuous phase. Using a combination of immiscible polymer formed polarization layer with a domain polarization layer and or a stacked layered polarization layer also provides useful embodiments in this invention. Mixing and matching these parameters (types of polarization film) is useful in providing the optimal polarization effect as well as overall light control for shaping, collimation, spread and or spectrum control. Additionally features may be formed into the one or more of the major surfaces of the polymeric film of this invention. The features may be continuous or discrete elements. They be patterned or random. The features may include lenlets, circular, elliptical, triangular, trilobal, or trapezoidal or pyramidal. Such features may be elongated in one or more directions. Such features may be formed directly into the polarization layer or to a separate layer on or otherwise attached to the polarization layer.

The diffusely reflecting polarizer may be adhered to one or more layers to provide physical and or optical properties. This may include a slab diffuser, a back diffuser, a light enhancement film, a liquid crystal containing layer, a color filter, and or stiffening sheet or member. These sheets, layers and member may have a thickness range of between 1 and 800 microns (individually or in combination with each other.

### Further Definitions

As used herein, the term “extinction ratio” (ER) is defined to mean the ratio of total light transmitted in one polarization to the light transmitted in an orthogonal polarization.

The indices of refraction of the continuous and discontinuous phases are substantially matched (i.e., differ by less than about 0.05) along a first of three mutually orthogonal axes, and are substantially mismatched (i.e., differ by more than about 0.05) along a second of three mutually orthogonal axes. Preferably, the indices of refraction of the continuous and discontinuous phases differ by less than about 0.03 in the match direction, more preferably, less than about 0.02, and most preferably, less than about 0.01. The indices of refraction of the continuous and discontinuous phases preferably differ in the mismatch direction by at least about 0.07, more preferably, by at least about 0.1, and most preferably, by at least about 0.2.

The mismatch in refractive indices along a particular axis has the effect that incident light polarized along that axis will be substantially scattered, resulting in a significant amount of reflection. By contrast, incident light polarized along an axis in which the refractive indices are matched will be spectrally transmitted or reflected with a much lesser degree of scattering. This effect can be utilized to make a variety of optical devices, including reflective polarizers and mirrors.

### Effect of Index Match/Mismatch

The magnitude of the index match or mismatch along a particular axis directly affects the degree of scattering of light polarized along that axis. In general, scattering power varies as the square of the index mismatch. Thus, the larger the index mismatch along a particular axis, the stronger the scattering of light polarized along that axis. Conversely, when the mismatch along a particular axis is small, light polarized along that axis is scattered to a lesser extent and is thereby transmitted specularly through the volume of the body.

### Skin Layers

A layer of material which is substantially free of a discontinuous phase may be disposed on one or both major surfaces of the film, i.e., the extruded composite the discontinuous phase and the continuous phase. The composition of the layer, also called a skin layer, may be chosen, for example, to protect the integrity of the discontinuous phase within the extruded blend, to add mechanical or physical properties to the final film or to add optical functionality to the final film. Suitable materials of choice may include the material of the continuous phase or the material of the discontinuous phase.

A skin layer or layers may also add physical strength to the resulting composite or reduce problems during processing, such as, for example, reducing the tendency for the film to split during the orientation process. Skin layer materials which remain amorphous may tend to make films with a higher toughness, while skin layer materials which are semicrystalline may tend to make films with a higher tensile modulus. Other functional components such as antistatic additives, UV absorbers, dyes, antioxidants, and pigments, may be added to the skin layer, provided they do not substantially interfere with the desired optical properties of the resulting product.

The skin layers may be applied to one or two sides of the extruded blend at some point during the extrusion process, i.e., before the extruded blend and skin layer(s) exit the extrusion die. This may be accomplished using conventional coextrusion technology, which may include using a three-layer coextrusion die. Lamination of skin layer(s) to a previously formed film of an extruded blend is also possible. Total skin layer thicknesses may range from about 2% to about 50% of the total blend/skin layer thickness.

A wide range of polymers are suitable for skin layers. Predominantly amorphous polymers include copolyesters based on one or more of terephthalic acid, 2,6-naphthalene dicarboxylic acid, isophthalic acid phthalic acid, or their alkyl ester counterparts, and alkylene diols, such as ethylene glycol. Examples of semicrystalline polymers are 2,6-polyethylene naphthalate, polyethylene terephthalate, and nylon materials.

### Antireflection Layers

The films and other optical devices made in accordance with the invention may also include one or more anti-reflective layers. Such layers, which may or may not be polarization sensitive, serve to increase transmission and to reduce reflective glare. An anti-reflective layer may be imparted to the films and optical devices of the present invention through appropriate surface treatment, such as coating or sputter etching.

In some embodiments of the present invention, it is desired to maximize the transmission and/or minimize the specular reflection for certain polarizations of light. In these embodiments, the optical body may comprise two or more layers in which at least one layer comprises an anti-reflection system in close contact with a layer providing the continuous and discontinuous phases. Such an anti-reflection system acts to reduce the specular reflection of the incident light and to increase the amount of incident light that enters the portion of the body comprising the continuous and discontinuous layers. Such a function can be accomplished by a variety of means well known in the art. Examples are quarter wave anti-reflection layers, two or more layer anti-reflective stack, graded index layers, and graded density layers. Such antireflection functions can also be used on the transmitted light side of the body to increase transmitted light if desired.

More than Two Phases

The optical bodies made in accordance with the present invention may also consist of more than two phases. Thus, for example, an optical material made in accordance with the present invention can consist of two different discontinuous phases within the continuous phase. The second discontinuous phase could be randomly or nonrandomly dispersed throughout the polymer domains s, and can be aligned along a common axis.

Optical bodies made in accordance with the present invention may also consist of more than one continuous phase. Thus, in some embodiments, the optical body may include, in addition to a first continuous phase and a discontinuous phase, a second phase which is co-continuous in at least one dimension with the first continuous phase. In one particular embodiment, the second continuous phase is a porous, sponge-like material which is coextensive with the first continuous phase (i.e., the first continuous phase extends through a network of channels or spaces extending through the second continuous phase, much as water extends through a network of channels in a wet sponge). In a related embodiment, the second continuous phase is in the form of a dendritic structure which is coextensive in at least one dimension with the first continuous phase.

### Multilayer Combinations

If desired, one or more sheets of a continuous/disperse phase film made in accordance with the present invention may be used in combination with, or as a component in, a multilayered film (i.e., to increase reflectivity). Suitable multilayered films include those of the type described in WO 95/17303 (Ouderkirk et al.). In such a construction, the individual sheets may be laminated or otherwise adhered together or may be spaced apart with the polymeric sheet of this invention. If the optical thicknesses of the phases within the sheets are substantially equal (that is, if the two sheets present a substantially equal and large number of scatterers to incident light along a given axis), the composite will reflect, at somewhat greater efficiency, substantially the same band width and spectral range of reflectivity (i.e., “band”) as the individual sheets. If the optical thicknesses of phases within the sheets are not substantially equal, the composite will reflect across a broader band width than the individual phases. A composite combining mirror sheets with polarizer sheets is useful for increasing total reflectance while still polarizing transmitted light.

### Additives

The optical materials of the present invention may also comprise other materials or additives as are known to the art. Such materials include pigments, dyes, binders, coatings, fillers, compatibilizers, antioxidants (including sterically hindered phenols), surfactants, antimicrobial agents, antistatic agents, flame retardants, foaming agents, lubricants, reinforcers, light stabilizers (including UV stabilizers or blockers), heat stabilizers, impact modifiers, plasticizers, viscosity modifiers, and other such materials. Furthermore, the films and other optical devices made in accordance with the present invention may include one or more outer layers which serve to protect the device from abrasion, impact, or other damage, or which enhance the processability or durability of the device.

Suitable lubricants for use in the present invention include calcium sterate, zinc sterate, copper sterate, cobalt sterate, molybdenum neodocanoate, and ruthenium (III) acetylacetonate.

Antioxidants useful in the present invention include 4,4′-thiobis-(6-t-butyl-m-cresol), 2,2′-methylenebis-(4-methyl-6-t-butyl-butylphenol), octadecyl-3,5-di-t-butyl-4-hydroxyhydrocinnamate, bis-(2,4-di-t-butylphenyl) pentaerythritol diphosphite, Irganox™ 1093 (1979)(((3,5-bis(1,1-dimethylethyl)-4-hydroxyphenyl)methyl)-dioctadecyl ester phosphonic acid), Irganox™ 1098 (N,N′-1,6-hexanediylbis(3,5-bis(1,1-dimethyl)-4-hydroxy-benzenepropanamide), Naugaard™ 445 (aryl amine), Irganox™ L 57 (alkylated diphenylamine), Irganox™ L 115 (sulfur containing bisphenol), Irganox™ LO 6 (alkylated phenyl-delta-napthylamine), Ethanox 398 (fluorophosphonite), and 2,2′-ethylidenebis(4,6-di-t-butylphenyl)fluorophosnite. A group of antioxidants that are especially preferred are sterically hindered phenols, including butylated hydroxytoluene (BHT), Vitamin E (di-alphatocopherol), Irganox™ 1425WL (calcium bis-(O-ethyl(3,5-di-t-butyl-4-hydroxybenzyl))phosphonate), Irganox™ 1010 (tetrakis(methylene(3,5,di-t-butyl-4-hydroxyhydrocinnamate))methane), Irganox™ 1076 (octadecyl 3,5-di-tert-butyl-4-hydroxyhydrocinnamate), Ethanox™ 702 (hindered bis phenolic), Etanox 330 (high molecular weight hindered phenolic), and Ethanox™ 703 (hindered phenolic amine).

Dichroic dyes are a particularly useful additive in some applications to which the optical materials of the present invention may be directed, due to their ability to absorb light of a particular polarization when they are molecularly aligned within the material. When used in a film or other material which predominantly scatters only one polarization of light, the dichroic dye causes the material to absorb one polarization of light more than another. Suitable dichroic dyes for use in the present invention include Congo Red (sodium diphenyl-bis-oc-naphthylamine sulfonate), methylene blue, stilbene dye (Color Index (CI)=620), and 1,1′-diethyl-2,2′-cyanine chloride (CI=374 (orange) or CI=518 (blue)). The properties of these dyes, and methods of making them, are described in E. H. Land, Colloid Chemistry (1946). These dyes have noticeable dichroism in polyvinyl alcohol and a lesser dichroism in cellulose. A slight dichroism is observed with Congo Red in PEN.

Other suitable dyes include the following materials: [CHEM-1] The properties of these dyes, and methods of making them, are discussed in the Kirk Othmer Encyclopedia of Chemical Technology, Vol. 8, pp. 652-661 (4th Ed. 1993), and in the references cited therein.

When a dichroic dye is used in the optical bodies of the present invention, it may be incorporated into either the continuous or discontinuous phase. However, it is preferred that the dichroic dye is incorporated into the discontinuous phase.

Dychroic dyes in combination with certain polymer systems exhibit the ability to polarize light to varying degrees. Polyvinyl alcohol and certain dichroic dyes may be used to make films with the ability to polarize light. Other polymers, such as polyethylene terephthalate or polyamides, such as nylon-6, do not exhibit as strong an s ability to polarize light when combined with a dichroic dye. The polyvinyl alcohol and dichroic dye combination is said to have a higher dichroism ratio than, for example, the same dye in other film forming polymer systems. A higher dichroism ratio indicates a higher ability to polarize light.

Molecular alignment of a dichroic dye within an optical body made in accordance with the present invention is preferably accomplished by stretching the optical body after the dye has been incorporated into it. However, other methods may also be used to achieve molecular alignment. Thus, in one method, the dichroic dye is crystallized, as through sublimation or by crystallization from solution, into a series of elongated notches that are cut, etched, or otherwise formed in the surface of a film or other optical body, either before or after the optical body has been oriented. The treated surface may then be coated with one or more surface layers, may be incorporated into a polymer matrix or used in a multilayer structure, or may be utilized as a component of another optical body. The notches may be created in accordance with a pattern or diagram, and the amount of spacing between the notches, so as to achieve desirable optical properties.

In a related embodiment, the dichroic dye may be disposed within one or more domain or other conduits, either before or after the hollow domains or conduits are disposed within the optical body. The domain or conduits may be constructed out of a material that is the same or different from the surrounding material of the optical body.

In yet another embodiment, the dichroic dye is disposed along the layer interface of a multilayer construction, as by sublimation onto the surface of a layer before it is incorporated into the multilayer construction. In still other embodiments, the dichroic dye is used to at least partially backfill the voids in a microvoided film made in accordance with the present invention.

### Functional Layers

Various functional layers or coatings may be added to the optical films and devices of the present invention to alter or improve their physical or chemical properties, particularly along the surface of the film or device. Such layers or coatings may include, for example, slip agents, low adhesion backside materials, conductive layers, antistatic coatings or films, barrier layers, flame retardants, UV stabilizers, abrasion resistant materials, optical coatings, or substrates designed to improve the mechanical integrity or strength of the film or device.

The films and optical devices of the present invention may be given good slip properties by treating them with low friction coatings or slip agents, such as polymer beads coated onto the surface. Alternately, the morphology of the surfaces of these materials may be modified, as through manipulation of extrusion conditions, to impart a slippery surface to the film; methods by which surface morphology may be so modified are described in U.S. Ser. No. 08/612,710.

In some applications, as where the optical films of the present invention are to be used as a component in adhesive tapes, it may be desirable to treat the films with low adhesion backsize (LAB) coatings or films such as those based on urethane, silicone or fluorocarbon chemistry. Films treated in this manner will exhibit proper release properties towards pressure sensitive adhesives (PSAs), thereby enabling them to be treated with adhesive and wound into rolls. Adhesive tapes made in this manner can be used for decorative purposes or in any application where a diffusely reflective or transmissive surface on the tape is desirable.

The films and optical devices of the present invention may also be provided with one or more conductive layers. Such conductive layers may comprise metals such as silver, gold, copper, aluminum, chromium, nickel, tin, and titanium, metal alloys such as silver alloys, stainless steel, and intone, and semiconductor metal oxides such as doped and undoped tin oxides, zinc oxide, and indium tin oxide (ITO).

The films and optical devices of the present invention may also be provided with antistatic coatings or films. Such coatings or films include, for example, V₂O₅ and salts of sulfonic acid polymers, carbon or other conductive metal layers.

The optical films and devices of the present invention may also be provided with one or more barrier films or coatings that alter the transmissive properties of the optical film towards certain liquids or gases. Thus, for example, the devices and films of the present invention may be provided with films or coatings that inhibit the transmission of water vapor, organic solvents, O 2, or CO 2 through the film. Barrier coatings will be particularly desirable in high humidity environments, where components of the film or device would be subject to distortion due to moisture permeation.

The optical films and devices of the present invention may also be treated with flame retardants, particularly when used in environments, such as on airplanes, that are subject to strict fire codes. Suitable flame retardants include aluminum trihydrate, antimony trioxide, antimony pentoxide, and flame retarding organophosphate compounds.

The optical films and devices of the present invention may also be provided with abrasion-resistant or hard coatings, which will frequently be applied as a skin layer. These include acrylic hardcoats such as Acryloid A-11 and Paraloid K-120N, available from Rohm & Haas, Philadelphia, Pa.; urethane acrylates, such as those described in U.S. Pat. No. 4,249,011 and those available from Sartomer Corp., Westchester, Pa.; and urethane hardcoats obtained from the reaction of an aliphatic polyisocyanate (e.g., Desmodur N-3300, available from Miles, Inc., Pittsburgh, Pa.) with a polyester (e.g., Tone Polyol 0305, available from Union Carbide, Houston, Tex.).

The optical films and devices of the present invention may further be laminated to rigid or semi-rigid substrates, such as, for example, glass, metal, acrylic, polyester, and other polymer backings to provide structural rigidity, weatherability, or easier handling. For example, the optical films of the present invention may be laminated to a thin acrylic or metal backing so that it can be stamped or otherwise formed and maintained in a desired shape. For some applications, such as when the optical film is applied to other breakable backings, an additional layer comprising PET film or puncture-tear resistant film may be used.

The optical films and devices of the present invention may also be provided with shatter resistant films and coatings. Films and coatings suitable for this purpose are described, for example, in publications EP 592284 and EP 591055, and are available commercially from 3M Company, St Paul, Minn.

Various optical layers, materials, and devices may also be applied to, or used in conjunction with, the films and devices of the present invention for specific applications. These include, but are not limited to, magnetic or magneto-optic coatings or films; liquid crystal panels, such as those used in display panels and privacy windows; photographic emulsions; fabrics; prismatic films, such as linear Fresnel lenses; brightness enhancement films; holographic films or images; embossable films; anti-tamper films or coatings; IR transparent film for low emissivity applications; release films or release coated paper; and polarizers or mirrors.

Multiple additional layers on one or both major surfaces of the optical film are contemplated, and can be any combination of aforementioned coatings or films. For example, when an adhesive is applied to the optical film, the adhesive may contain a white pigment such as titanium dioxide to increase the overall reflectivity, or it may be optically transparent to allow the reflectivity of the substrate to add to the reflectivity of the optical film.

In order to improve roll formation and convertibility of the film, the optical films of the present invention may also comprise a slip agent that is incorporated into the film or added as a separate coating. In most applications, slip agents will be added to only one side of the film, ideally the side facing the rigid substrate in order to minimize haze.

More than Two Phases

The optical bodies made in accordance with the present invention may also consist of more than two phases. Thus, for example, an optical material made in accordance with the present invention can consist of two different discontinuous phases within the continuous phase. Optical bodies made in accordance with the present invention may also consist of more than one continuous phase. Thus, in some embodiments, the optical body may include, in addition to a first continuous phase and a discontinuous phase, a second phase which is co-continuous in at least one dimension with the first continuous phase.

### Region of Spectrum

While the present invention is frequently described herein with reference to the visible region of the spectrum, various embodiments of the present invention can be used to operate at different wavelengths (and thus frequencies) of electromagnetic radiation through appropriate scaling of the components of the optical body. Thus, as the wavelength increases, the linear size of the components of the optical body may be increased so that the dimensions of these components, measured in units of wavelength, remain approximately constant.

Of course, one major effect of changing wavelength is that, for most materials of interest, the index of refraction and the absorption coefficient change. However, the principles of index match and mismatch still apply at each wavelength of interest, and may be utilized in the selection of materials for an optical device that will operate over a specific region of the spectrum. Thus, for example, proper scaling of dimensions will allow operation in the infrared, near-ultraviolet, and ultra-violet regions of the spectrum. In these cases, the indices of refraction refer to the values at these wavelengths of operation, and the body thickness and size of the discontinuous phase scattering components may also be approximately scaled with wavelength. Even more of the electromagnetic spectrum can be used, including very high, ultrahigh, microwave and millimeter wave frequencies. Polarizing and diffusing effects will be present with proper scaling to wavelength and the indices of refraction can be obtained from the square root of the dielectric function (including real and imaginary parts). Useful products in these longer wavelength bands can be diffuse reflective polarizers and partial polarizers.

In some embodiments of the present invention, the optical properties of the optical body vary across the wavelength band of interest. In these embodiments, materials may be utilized for the continuous and/or discontinuous phases whose indices of refraction, along one or more axes, varies from one wavelength region to another.

Thickness of Optical Body

The thickness of the optical body is also an important parameter which can be manipulated to affect reflection and transmission properties in the present invention. As the thickness of the optical body increases, diffuse reflection also increases, and transmission, both specular and diffuse, decreases. Thus, while the thickness of the optical body will typically be chosen to achieve a desired degree of mechanical strength in the finished product, it can also be used to directly to control reflection and transmission properties.

Thickness can also be utilized to make final adjustments in reflection and transmission properties of the optical body. Thus, for example, in film applications, the device used to extrude the film can be controlled by a downstream optical device which measures transmission and reflection values in the extruded film, and which varies the thickness of the film (i.e., by adjusting extrusion rates or changing casting wheel speeds) so as to maintain the reflection and transmission values within a desired range.

### Geometry of Discontinuous Phase

While the index mismatch is the predominant factor relied upon to promote scattering in the films of the present invention (i.e., a diffuse mirror or polarizer made in accordance with the present invention has a substantial mismatch in the indices of refraction of the continuous and discontinuous phases along at least one axis), the geometry of the discontinuous phase can have a secondary effect on scattering. Thus, the depolarization factors of the particles for the electric field in the index of refraction match and mismatch directions can reduce or enhance the amount of scattering in a given direction. For example, when the discontinuous phase is elliptical in a cross-section taken along a plane perpendicular to the axis of orientation, the elliptical cross-sectional shape of the discontinuous phase contributes to the asymmetric diffusion in both back scattered light and forward scattered light. The effect can either add or detract from the amount of scattering from the index mismatch, but generally has a small influence on scattering in the preferred range of properties in the present invention.

The shape of the discontinuous phase can also influence the degree of diffusion of light scattered from the particles. This shape effect is generally small but increases as the aspect ratio of the geometrical cross-section of the particle in the plane perpendicular to the direction of incidence of the light increases and as the particles get relatively larger. In general, in the operation of this invention, the discontinuous phase should be sized less than several wavelengths of light in one or two mutually orthogonal dimensions if diffuse, rather than specular, reflection is preferred.

Preferably, for a low loss reflective polarizer, the preferred embodiment consists of a discontinuous phase disposed within the continuous phase as a series of rod-like structures which, as a consequence of orientation, have a high aspect ratio which can enhance reflection for polarizations parallel to the orientation direction by increasing the scattering strength and dispersion for that polarization relative to polarizations perpendicular to the orientation direction.

The invention has been described in detail with particular reference to certain preferred embodiments thereof, but it will be understood that variations and modifications can be effected within the spirit and scope of the invention. The entire contents of the patents and other publications referred to in this specification are incorporated herein by reference.

List of Potential Problems that May Require Solutions:
Develop expanded text (disclosures or new patents) to incorporate the list of potential problems. Define the problem and solution.

### Shape Control:

The shape of the second polymeric material may be impacted by the relative melt viscosities of the two or more polymers and also any thermal gradients within the extrusion system that can effect the relative interfacial tension of the polymers. Additives known in the art as compatibilizers may be added to either or both polymers. Improved control of the melt processing process will also provide improved control of the domains shapes.

### Stretching:

The cast sheet of polymer may be stretched in at least one direction. In the machine or running direction of the film, the final shapes will be elongated in the continuous running direction but their cross-sectional end dimension with get smaller but the general shape will be similar to that of the pre-stretched shape. If stretched in the cross direction the crossectional shape will become more elongated. For example a circular shape will appear as a oval of even plate-like after stretching. The samples may also be stretched in both directions either one after the other or simultaneously.

Stretching may not only impact the shape of the domain but also impacts the relative degree or amount of birefringence. M The process of claim 1 wherein said diffusely reflecting polazier has a dimensional change of less than 1% at 60 C. Matching at least one orthogonal direction provides improved optical performance for the films polarization effect. Matching two of the three vectors of birefringence will further improve the optical performance of the film. Stretching temperature also plays an important role in the amount of birefringence developed in the domains and the continuous phase polymer.

Skin layer may be added to improve:
A) physical performance such as stiffness, dimensional change. Layers may be added to prevent scratching or abrasion, fingerprinting, (hard coat technology, IR heat shield
B) Optical performance-match RI of the core polarizing sheet. Add to one or both side. May be a different materials, It may be structured to enhance light performance or function. Roughness control, light diffusion (voids and or particles), surface scattering, collimation. The surface may have a feature-bead, lens shape, continuous or individual features
C) The skin layer(s) may be removal, antistats may be added for static control. Conductive layer may be added (EM shielding, LC control, IR heat shield)
D) Removal skin may be used for dirt control, the removal skin can also impact the final surface Ra of the film (casting replication) Domain shape and their size as well as the spacing between the domains will have an impact on the color shift of the film, the degree or amount of light transmission (broad-band or narrow light control) The shape may be random in appearance but still substantially spatially defined. The domains may be a variety of shapes and sizes. The domains may be patterned across the width to provide a difference in the light distribution from edge to center. May also be done in combination with other means of light control and shaping. (surface or internal).
   The optical element may have more than one layer of polarization features. Ie a stacked of layer that are adhered together or other stacked one on top of each other. There may be a spacer layer between the layers. They be laminated or coextruded. The layers of polarization may be of different types—domains, fibrils, immiscible polymer, stacked layer or other means.
   The density of the domains may vary in the thickness dimension to form a gradient in refractive index.
   The fibril-like domains and or the surrounding matrix polymer may have additives to further enhance or otherwise modify their optical performance. Modify the RI or birefringence or the domains. The addition of LC or other crystals to enhance their polarization effect.
   The domains useful in this invention may also be backscattering or they may be forward scattering.

| Potential Problems | Solutions |
|---|---|
| shape control-interfacial tension | See compatibilizers |
| actual shape - round, | Non-ribbon-like |
| compatibilizers | Control of domains shape |
| orientation | MD, CD or simul |
| combination of added layer on top and bottom | Change the physical or optical |
| | performance (ie dimensional stability) |
| stretching | Optics, control of refractive index of x, y |
| | and z |
| skin layer on top of film | Strength, optics, improved mfg |
| Schrenk plus removal skin layer | Protection layers (replace masking films, |
| | dirt control, surface smoothness) |
| immiscible blend in the ribbon or matrix | See below |
| distribution of sizes for color shift and | Optical performance, wavelength specific |
| broadband | control, color shift control |
| non-random | |
| distribution of shapes | optics |
| 2 ribbon films stacked (coext, laminated . . . etc) | Increased performance |
| Refractive index gradient | Vary density of ribbons as a function of the |
| | thickness, more or less additives to the |
| | domains to vary the RI in the thickness |
| | plane or in regions |
| LC particles within a film or layer | Enhanced performance, change |
| | alignment by electrical field. |
| light control structure on top of ribbon film | Pattern of shape for light control, shaping |
| | . . . etc |
| gloss surface | |
| matte or rough surface (diffusely vs spectral | Also patterned surface |
| reflectance) | |
| antistat in combination with film | Dirt control, sticking of films |
| ribbon plus adhesive | Combination film |
| ribbon film plus added functional layer (AR, IR | Use in display article or lens applications |
| reflecting, coating, barrier . . . etc) | |
| charged ribbon vs matrix | Conductive domains |
| use in a display - lcd, oled, other | Application space |
| in combination with other films | Combination films |
| define range of FOM | 1.2-2.0 |
| 2 different ribbon materials | Create different regions, optimize |
| | performance |
| 2 or more extruders | Method and use of different materials |
| solvent cast | Means of making |
| ribbon plus dbef or other | Cobination with other means of |
| | polarization or funtionality |
| both phases may be birefringent | The difference is important |
| heat process to remove birefringence from the | See below |
| matrix | |
| sps ribbon/pEN matrix | See materials |
| no continuous phase (alternating block of | Novel means to create polarizer |
| isotropic and birefringent polymers | |
| number of ribbons | optics |
| size of ribbons | Opportunity for interface |
| space between ribbons in Z and y dimensions | Optimize optical performance |
| density of ribbons | Optical performance |
| other potential uses | |
| with back light or side light - LED, other lights | Future application |
| combination with a diffuse layer (POPET) | All in one/combined functionality |
| coext a ribbon as 1 layer and an immiscible | Two or more ways to create polarization |
| polymer layers | and or enhance other optics (diffuses |
| | reflective) Impact physical properties |
| means of making a die and or orifice plates | Coathanger, multi-manifold dies for |
| | additional layers-Removal skin layer for |
| | protection, added dimensional stability, |
| | modify a. |
| | The use of photolithography as well as |
| | etching to form small features as well as to |
| | create a means that would allow millions |
| | of domains in a film. This is different and |
| | improved over flow multiplers. |
| | Micro-machine in combination with |
| | photolith and etching |
| photolith method in combination w a film with | Able to create finer patterns |
| islands in the sea | Create different shapes than can be done |
| | by machines. |
| define the best materials | Negative birefringent for one phase with |
| | high birefringent for the other, materials for |
| | best clarity |
| side light, direct backlight | TV, monitors, LED, CFFL |
| combination with LEX | Polarizer light after extraction/put LEX or |
| | other surface pattern on this film |
| Big and very big ribbons | |
| dimensions of the ribbon (> than 2 in the | Define what/hen domains are different |
| width) | than stacked layers |
| combination with a coated layer | Added functionality/combination for optics, |
| | physical properties |
| melt temp delta between polymers | Heat processing to reduce the |
| | birefringence of the matrix ans enhance |
| | the optical performance |
| temp for stretching | Can impact the amount of birefringence |
| dimensional stability of the final film | Performance in a stack, environmental |
| | control |
| change shape of the ribbon (domains) vs | Frictional drag to control/alter shape of |
| position to the extruder wall | some domains |
| addenda to polymer to control some properties | |
| (RI, opacity, conductivity, viscosity, color, | |
| others) | |
| UV absorbers, slip agents, thermal stabilizers | Polymer and article control/life |
| Tg of matrix > 80 C. | |
| inorganic polymers in ribbon | Polymer stability, light fade, light control, |
| | conductivity, viscosity control during |
| | making |
| porocess - ext on to belt, roller . . . etc | Method |
| combination with EMF layer | Conductive layer, protect humans, protect |
| | LC's from changing |
| wherein the melt curtain is stretched prior to | Melt draw down may improve optics and |
| quenching (2/1 to >100/1)-may need | physical properties |
| branched material for melt strength, provides | |
| alignment | |
| where in the film is stretched after quenching - | Shape control for optics, # of optical |
| MD, CD, simultaneously | interfaces, light control-columniation |
| Article claim for a display with this type of | Application space |
| polarizer | % transparent vs. % reflectance/Better |
| Vary spacing/domains size to change from | FOM |
| diffuse and spectral reflective polarizer | % transparent vs. % reflectance, turbid |
| Vary polymer type to change from diffuse to | polymers to scatter light |
| spectral reflective polarizer | Control of light output |
| Combination-hybrid polarizer that is part | Stiffer for TV applications, Reduced |
| diffuse and part spectral | number of films-less cost . . . etc |
| All in one film-extrude and or coat additional | Less diffuse/more transparent |
| functionality | More uniform optical performance. |
| In the same or separate layers | Improves Tmax and Rmax |
| Modify polymer to control the amount of | |
| crystalline | |

### PARTS LIST

10 is a stacked multi-layer reflective polarizer (prior art)
11 is a polymer layer of thickness A and refractive index A.
12 is a polymer layer of thickness A and refractive index B.
13 is the same polymer as used in layer 11 but with a different thickness C and refractive index A.
14 is the same polymer as used in layer 12 but with a different thickness C and refractive index B.
15 is the same polymer as used in layers 11 and 13 but with even another thickness D and refractive index A.
16 is the same polymer as used in layer 12 but with thickness D and refractive index B.
20 is an immiscible polymer blend with random domains of alternating polymer.
30 is a reflective polizier with second polymeric material fibrils
31 is a polymer fibril
32 is a continuous phase polymer
40 is a 3D view of a reflective polarizer with second polymeric material shape 41 is a elongated second polymeric material shape 42 is the continuous phase polymer
50 is a 3 dimensional view of an inventive film 50 with second polymeric material shape 51 is a triangular shaped second polymeric material
52 is a triangular shaped second polymeric material that has been slightly elongated
52 is a triangular shaped second polymeric material that has been elongated
60 is a cross sectional view of an inventive film 60 with second polymeric material shape that vary in shape and dimension.
61 is a circular second polymeric material shape
62 is a small elongated oval second polymeric material shape
63 is a large elongated oval shape second polymeric material shape
65 is an oval second polymeric material shape. 70 is a 3 dimensional view of a reflective polarizer with second polymeric material shape 71 is a ordered second polymeric material shape that varies shape within its cross-sectional thickness.
72 is a second polymeric material shape that varies in shape within its cross-sectional thickness.
80 is a 3 dimensional cross-sectional view of a reflective polarizer with no continuous second polymeric material in its width or thickness plane.
81 is polymer domain of polymer A with thickness A and refractive index A.
82 is a polymer domain of polymer B with thickness A and refractive index B.
83 is a polymer domain with polymer A and thickness A and refractive index A.
84 is a polymer domain with polymer B and thickness B and refractive index B.
90 is a cross sectional view of a reflective polarizer 90 with more than one size of second polymeric material shapes.
91 is a circular second polymeric material shape.
92 is an oval second polymeric material shape 93 is a continuous phase polymer
100. is a cross-sectional view of a multi-layer reflective polarizer
101 is a second polymeric material shape.
102 is a polymer skin layer
103 is a polymer skin layer
110 is a cross-sectional view of a two layer reflective polarizer
111 is a polarizing layer
112 is a core layer between 2 polarizing layers
120 is a cross sectional view on a reflective polarizer with second polymeric material shape with a patterned surfaces.
121 is second polymeric material shapes
122 is a cross sectional view on a reflective polarizer with second polymeric material shape with a patterned surfaces on a separate layer
123 is a separate film layer
124 is a cross sectional view on a reflective polarizer with second polymeric material shape with a patterned surfaces with internal polarizing elements in the features.
125 is an internal polarizing element.
126 is a cross sectional view on a reflective polarizer with second polymeric material shape with a patterned surfaces with surface features on the opposite side.
130 is a ribbon-like shape
131 is a ribbon-like shape with rounded corners
140 is a circular cylinder shape
141 is a slightly elongated cylinder shape
143 is a 3D cross-section view of a cylinder shape
145 is a 3D cross-section of an slightly oval cylinder-like shape
147 is a cylinder projection.
151 is a classical oval shape 151 to near egg shape
152 is an elongated oval shape
153 is an irregular shaped elongated oval-like shape 153
154 is a an irregular elongated oval-like shape
155 is an elongated oval-like shape projection plate-like shape 161 (fibril) 170 is an irregular shape fibril
171 is another irregular shape fibril also has no flat surfaces but does not appears to be a ribbon-like, cylinder-like or oval-like.
immiscible polymer domains
203 with stacked layers
205 is an oval-like continuous shape
immiscible polymer domains
immiscible polymer domains cylinder-like continuous shape with cylinder-like shape before stretching 212 with oval-like shape before stretching with cylinder-like shape before stretching is a cross section of fibril with a oval-like shape before stretching is a cross section of fibril with a cylinder-like shape after stretching
223 is a compressed oval shape when stretched in the machine direction 3D cross section of bi-component domain with discontinuous discrete domains.
241a is a half circle or half cylinder-like domain
242 is an half oval-like shape domain
243 is a half of an elongated shaped domain
245 is a multi-lobal shaped domain
251 is an enlarged end cross sections of a ribbon-like polymer domain
253 is an incoming light rays
255 is a reflected light ray
257 is an incoming light ray
259 is a reflected light ray
260 is a reflected light ray
261 is an enlarged curvilinear polymer domain
262 is enlarged representations of a multi-lamella film
263 is a multi-domain diffuse reflective polarizer

1. A process for making a multiphase birefringent film comprising (a) a first polymeric material forming a continuous phase in all directions and (b) a second polymeric material that is continuous in only one direction disposed within the first phase, the second polymeric material being predominately curvilinear in shape_and substantially extending the length of the film, at least one of the phases being birefringent and the two phases being substantially matched in refractive index in at least one direction_comprising the steps of:
i) forming said film by a melt extrusion process
ii) casting said film onto a surface that is at a temperature below the polymer melt temperature
iii) stretching said film in at least one direction at a temperature above the Tg of the continuous phase polymer to change the birefringence of the second polymeric material.
iv) heat stabilizing the film.

2. The process of making said film of claim 1 wherein said extrusion process comprises a spinneret.

3. The process of making said film of claim 2 wherein said spinneret provides polymer feed for at least one polymer.

4. The process of making said film of claim 2 wherein said spinneret provides separate polymer feed flows for each of the said second polymeric material of the film.

5. The process of making said film of claim 2 further comprises a flow multiplier

6. The process of making said film of claim 1 wherein said a second polymeric material that is continuous in only one direction disposed within the first phase, the second polymeric material being curvilinear in shape comprises fibrils.

7. The process of claim 1 wherein said arranging the said second polymeric material comprises at least 50 to 250 optical interfaces in the thickness dimension of the film.

8. The process of claim 1 wherein said second polymeric material comprise at least 250 to 500 optical interface in the thickness dimension of the film.

9. The process of claim 1 wherein said second polymeric material comprise at least 500 to 1000 optical interfaces in the thickness dimension of the film.

10. The process of claim 1 wherein said second polymeric material comprises at least 1000 optical interface in the thickness dimension of the film.

11. The process of claim 1 wherein said film's discontinuous phase second polymeric material and said continuous phase (first polymeric material) has a refractive index difference of greater than 0.02.

12. The process of claim 1 wherein said film second polymeric material predetermined domains and said continuous phase has a refractive index difference of greater than 0.05.

13. The process of claim 1 wherein said film's continuous phase is isotropic.

14. The process of claim 1 wherein said film's discontinuous phase is birefringent.

15. The process of claim 1 wherein said film's discontinuous phase is isotropic.

16. The process of claim 1 wherein said film's continuous phase is birefringent.

17. The process of claim 1 wherein said second polymeric material comprises polyethylene(terephthalate), polyethylene(naphthalate), or a copolymers thereof.

18. The process of claim 1 wherein said polymeric continuous phase comprises at least one material selected from the group consisting of polyester, an acrylic, a styrene, or an olefin and copolymers thereof.

19. The process of claim 18 wherein said polymeric continuous phase wherein the continuous phase comprises polyethylene(terephthalate), poly(methyl-methacrylate), poly(cyclo-olefin), synotaticpolystyrene, or and copolymers thereof.

20. The process of claim 18 wherein said polymeric continuous phase wherein the continuous phase comprises poly(1,4-cyclohexylene dimethylene terephthalate).

21-125. (canceled)
